(19) United States
(12) Patent Application Publication
(10) Pub. No.: US 2013/0013520 A1
(43) Pub. Date: Jan. 10, 2013

(54) ELECTRONIC LICENSING SYSTEM AND METHOD

(76) Inventor: Eugene M. Lee, Annandale, VA (US)

(21) Appl. No.: 13/619,393

(22) Filed: Sep. 14, 2012

Related U.S. Application Data
(63) Continuation of application No. 12/474,728, filed on May 29, 2009.
Application No. 12/474,728 is a division of application No. 10/229,273, filed on Aug. 28, 2002.
Application No. 10/229,273 is a continuation-in-part of application No. 09/875,943, filed on Jun. 8, 2001, now Pat. No. 6,662,178.
Application No. 09/875,943 is a continuation-in-part of application No. 09/875,937, filed on Jun. 8, 2001.
Application No. 09/875,937 is a continuation-in-part of application No. 09/875,954, filed on Jun. 8, 2001, now Pat. No. 6,694,331.
(60) Provisional application No. 60/315,021, filed on Aug. 28, 2001.
(60) Provisional application No. 60/277,282, filed on Mar. 21, 2001.

(51) Int. Cl. G06Q 50/26

(52) U.S. Cl. 705/310

(57) ABSTRACT

Information relating to intellectual property, across one or more intellectual property applications having various types of intellectual property data, can be provided and/or accessed in an integrated manner. Commonality(ies) are determined between disparate intellectual property applications, that may be applied by the intellectual property applications in accessing the intellectual property information. Responsive to a user request, which may include a specified commonality, stored information regarding the disparate data corresponding to the disparate intellectual property applications is retrieved. The commonality is utilized in bridging the gap to the intellectual property data for the disparate intellectual property applications. The bridging is provided by use of a commonality and by an IP engine.

### RELATED APPLICATIONS

This application is a divisional of U.S. patent application Ser. No. 10/229,273 filed on Aug. 28, 2002 and entitled “COMPUTERIZED INTELLECTUAL PROPERTY INTEGRATED OFFICE SYSTEM AND METHOD”, and claims priority to U.S. Provisional Application Ser. No. 60/315,021 filed Aug. 28, 2001, and all incorporated herein by reference.

### BACKGROUND OF THE INVENTION

1. Field of the Invention

The present invention is directed to computer-related and/or assisted systems, methods and computer readable mediums for analyzing, searching, and accessing information concerning intellectual property. More specifically, it relates to methods and systems for enabling the integration of and/or integration across a variety of intellectual property and/or intellectual property-related systems and/or information.

2. Description of the Related Art

A customer, or someone performing intellectual property (“IP”) work on behalf of a customer, utilizes an intellectual property system in the following way. The customer has selected one or more intellectual property systems or providers. A service provider (or its agent) has installed such system, for example, a docketing system, or has provided a service for, e.g., searching intellectual property information, depending on the capability of the intellectual property systems provider and/or an application from one or more providers. Each provider may focus on providing certain capabilities and one or more application programs, typically featuring those capabilities. Further complicating the situation is that each customer site may utilize a number of different providers, extracting electronically or even manually the desired information and/or other intellectual property characteristics.

Typically a customer has a selection of application programs, some or all of which may be provided e.g., as an ASP, that the customer has selected from among a number of competing intellectual property systems, based on the customer's unique needs. Where the application programs do not suit the customer's needs, the customer may bridge such gaps otherwise, including manually.

Conventionally, the various intellectual property systems do not interchange data, and are otherwise not compatible. Indeed, the various types of intellectual property applications, e.g., IP docketing, patent searching, trademark searching, analyzing, etc., are directed to different conceptually different practice issues and hence have focused on their different core issues. Further reflecting practice issues, the various types of intellectual property applications tend to permit access by a limited subset of users, e.g., docketing trained staff may access docket software, paralegals have passwords to search applications, IP licenses are available to attorneys, etc.

The term “application” as it is used herein is intended to generally include a program that performs one or more functions on behalf of the user, as distinguished from system software such as the operating system kernel and server processes, which exist to support application programs. The term is used fairly loosely, for instance, some might say that client software and server software together form an application that is distributed.

One familiar type of intellectual property application program is a docketing application program. Docketing application programs tend to focus on the issue of due dates and providing a means for tracking whether specified actions, e.g., reminders, status checks, filings, happen by certain dates. Hence, a docketing system may include methods to manually input information indicating that activity has occurred necessitating a due date, e.g., office action issued, and may include rules for determining dates based on such activity, e.g., response due and reminders etc. A docketing system typically will correlate due dates and any other information to a particular patent or trademark application, each of which generally stands on its own in a docketing system. Depending on the docketing system, it may even be difficult or impossible to query the system to ascertain whether any docketed applications are related. Docketing systems not only do not automatically relate to other types of intellectual property application programs, they sometimes do not automatically relate their own internal records.

Another familiar type of intellectual property application program relates to searching. There are a number of patent and/or trademark search programs currently available on the market. Various search parameters may be entered for various search fields, e.g., serial number, text strings, trademark, date filed, etc., and search results may be returned. Search results may include information indicating the most recent status of the intellectual property, e.g., patent application published, trademark application abandoned, office action issued, etc.

Many corporations are focusing on their IP assets as being quite valuable. Hence these companies strive to develop large intellectual property portfolios, and indeed spend time and money on these assets. There is a concomitant pressure to leverage and/or better manage these portfolios of IP assets. As a result, a great deal of emphasis has been placed on better ways to analyze the value of a portfolio, better processes for managing the portfolio and better strategies for creating opportunities to extract value from the portfolio. While these management techniques have resulted in more efficient use of attorney resources, and more targeted IP filings and funding, relatively little has been done to take advantage of current computational technologies, the integration of data resources (largely through the Internet), and better knowledge-based software systems to handle aspects of IP. As a result, no process or product exists for handling the full range of IP functions in an automated manner.

While portions of paperwork associated with the IP lifecycle have been automated, the applications used to perform many of the IP related tasks have not been fully integrated. As a result, many dysfunctions occur.

For example, the IP attorney, or other professional, creates large data sets that can be qualified as “work product”. That data set needs to be comprehensively managed. To do so, (particularly for managing the intellectual property information that is created in a single application), requires the development of a series of applications each of which are designed to perform discrete tasks. For many reasons, this information cannot be equally passed from one application to the other.

Moreover, certain of the information is set in time. For example, patent docketing applications are focused on the docketing and automated management of patent applications while those applications remain pending before the US Patent and Trademark Office. Other IP applications, to the extent they exist in automated form, also suffer from the same constraints. However, very little is available for patents or trademarks that have already issued. Moreover, no system exists for IP that is being licensed, that is being filed overseas, or that form the basis for an analysis used by an attorney.

Accordingly, there exists a need and in the market for a comprehensive system that incorporates tools that will give the intellectual property professional the ability to work in all aspects of their practice area using automated docketing, analysis, foreign filing, prosecution, organizer or administrative tools to prepare them in their practice.

I have determined that the ability to integrate these systems and/or electronically to interchange their information and/or to automatically drive each other is desirable, but is unfortunately not provided or supported by current systems. For example, although a search system includes information regarding status of the intellectual property, it does not push that information to other systems; meanwhile, a docketing system awaits such information to be input or otherwise provided by a user.

The integration system and/or engine of the present invention may be compatible with at least some intellectual property applications. Further, it may be compatible with a combination of one or more IP applications such as discussed in my U.S. patent applications “APPARATUS FOR AND METHOD OF SEARCHING AND ORGANIZING INTELLECTUAL PROPERTY INFORMATION UTILIZING A CLASSIFICATION SYSTEM”, Ser. No. 09/875,954, filed Jun. 8, 2001; “APPARATUS FOR A METHOD OF SEARCHING AND ORGANIZING INTELLECTUAL PROPERTY INFORMATION UTILIZING A FIELD-OF-SEARCH”, Ser. No. 09/875,937, filed Jun. 8, 2001; “APPARATUS FOR A METHOD OF SEARCHING AND ORGANIZING INTELLECTUAL PROPERTY INFORMATION UTILIZING AN IP THESAURUS”, Ser. No. 09/875,943, filed Jun. 8, 2001; “APPARATUS FOR AND METHOD OF SEARCHING AND ORGANIZING INTELLECTUAL PROPERTY INFORMATION,” Ser. No. 09/875,937, filed Jun. 8, 2001; “FEE TRANSACTION SYSTEM AND METHOD FOR INTELLECTUAL PROPERTY ACQUISITION AND/OR MAINTENANCE,” Ser. No. 09/460,806, filed Dec. 14, 1999; “SYSTEMS AND METHODS FOR PREPARATION OF AN INTELLECTUAL PROPERTY FILING IN ACCORDANCE WITH JURISDICTION AND/OR AGENT-SPECIFIC REQUIREMENTS,” Ser. No. 09/409,524, filed Sep. 30, 1999; and/or “APPARATUS AND METHOD OF ANALYZING INTELLECTUAL PROPERTY INFORMATION”, Ser. No. 10/101,749, filed Mar. 21, 2002; all of which are expressly incorporated herein by reference.

Accordingly, I have determined that the complexities affecting the analysis, use, accessing, researching, presenting, etc., of intellectual property and related information make it extremely difficult for a customer to integrate information in various scenarios. I have determined that a customer might want to determine, e.g. which patents are implicated by a license for a particular product. Related questions include which patents should be maintained. Further, a customer might want to determine how much it costs to file foreign applications, and then might want to simply proceed to file those foreign applications.

Unfortunately, conventional systems fail to bridge the gap between intellectual property applications. They fail to explore the potential uses of the information that may be collected and integrated. Moreover, none of these conventional systems permit the customer to perform its own planning, exploration of information, and/or re-use of information, according to the parameters that the customer defines as important. Thus, using conventional systems, it is not possible to integrate the various types of information relating to intellectual property. There remains a need in intellectual property, corporate management, accounting, etc. for such a system.

### BRIEF SUMMARY OF THE INVENTION

The present invention alleviates the deficiencies of conventional techniques and systems described above. It provides for an integrated suite of applications that are designed to better meet the IP professional's needs, preferably, in every category and which uses technology to provide software and services to an IP customer in an efficient manner. According to certain aspects of the present invention, there are provided a host of IP-related functions, optionally through the use of an application service provider (“ASP”) platform. Further in accordance with other aspects of the present invention, there may be provided an integrated IP management engine, which integrates data, and applications software as well as on-going services for the user. Accordingly, there may be provided in accordance with one or more embodiments of the present invention an integrated system or method that seamlessly provides data from one type of IP work to another. The concepts of the present invention are not limited to patents, but may also be used in connection with other types of IP, as broadly defined, such as trademarks, copyrights, mark works, licensing activity, trade secrets, sui generis protection, etc. For example, according to at least some embodiments, the present invention may associate patents with licensing activity, copyright applications with analysis or patent activity with foreign filing, licensing, docketing, annuities, and/or prosecution.

The invention provides a method, system, and computer program device for providing and/or accessing information relating to intellectual property, in an integrated manner, across one or more intellectual property applications having various types of intellectual property data, including at least two intellectual property applications having at least partially different types of intellectual property. The invention provides for accessing intellectual property data in a first of at least two intellectual property applications. Further, invention provides for determining at least one commonality applied by the at least two intellectual property applications for data representative of an intellectual property characteristic, in accessing the intellectual property information, wherein the commonality corresponds to at least one type of data in the at least two intellectual property applications. Further, the invention provides for accessing information regarding the data representative of an other intellectual property characteristic in a second of the two intellectual property applications, responsive to the determined commonality.

According to one or more embodiments of the present invention, the commonality comprises data representative of information that is not present in at least one of the intellectual property applications.

According to one or more embodiments of the present invention, the intellectual property may be one or more of: trademark, patent, copyright, trade secret, sui generis protection, and licensing.

In accordance with one or more embodiments of the present invention, the intellectual property application(s) may be one or more of: analysis, foreign filing, licensing, docketing, annuities, prosecutor, filing, and organizer.

In accordance with one or more embodiments of the present invention, there is further provided for collecting of intellectual property related information representative of at least one characteristic of at least one of the intellectual properties utilized by the user.

Further, according to one or more embodiments of the present invention, there is further provided for generating the information for the user responsive to the presence, the information relating to the user and the commonality.

According to one or more embodiments of the present invention, there is further provided for interfacing, via the at least one commonality, with an enterprise resource planning application.

Also, according to one or more embodiments of the present invention, there is provided an engine, wherein the user interfaces with at least one of the intellectual property applications via the engine, and the engine accesses the at least two intellectual property applications utilizing the determined commonality.

There is further provided, in accordance with one or more embodiments of the present invention, adding at least one additional intellectual property application, and determining at least a second commonality between the additional intellectual property application and one of the at least two intellectual property applications.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE SEVERAL VIEWS OF THE DRAWING(S)

The above-mentioned and other advantages and features of the present invention will be better understood from the following detailed description of the invention with reference to the accompanying drawings, in which:

FIG. 1 is a block diagram of one example of an integrated IP system for use with an IP engine, according to the present invention.

FIG. 2 is a data flow diagram illustrating one example of an integrated IP system for use with an IP engine, according to the present invention.

FIG. 3 is a block diagram illustrating one example of the IP engine of the present invention used in connection with a networked architecture including the Internet.

FIG. 4 is a block diagram illustrating one embodiment of the data flow between the IP engine, and IP applications utilizing commonalities, according to the present invention.

FIG. 5 is a block diagram illustrating an alternative embodiment of the data flow between the IP engine, and IP applications utilizing commonalities, according to the present invention.

FIG. 6 is a flow chart illustrating one example of a flow for the IP engine, according to the present invention.

FIG. 7 shows a block diagram of a computer used for implementing the IP integration in accordance with a computer implemented embodiment of the present invention.

FIG. 8 illustrates a block diagram of the internal hardware of the computer of FIG. 7.

FIG. 9 is a function block diagram of one embodiment of an IP docketing tool, according to the present invention.

FIG. 10 is a function block diagram of one embodiment of an IP analyzer tool, according to the present invention.

FIG. 11 is a function block diagram of one embodiment of an IP licensing tool, according to the present invention.

FIG. 12 is a continuation function block diagram showing the above IP licensing tool.

FIG. 13 is a function block diagram illustrating one embodiment of an IP prosecutor tool, according to the present invention.

FIG. 14 is a function block diagram of one embodiment of an IP foreign filer tool, according to the present invention.

FIG. 15 is a function block diagram of one embodiment of an IP annuity tool, according to the present invention.

FIG. 16 is a function block diagram of one embodiment of an IP organizer, according to the present invention.

FIG. 17 illustrates one embodiment of an opening sequence for accessing a system according to the present invention.

FIG. 18 is a detailed flowchart showing one embodiment of an IP docketing application, according to the present invention.

FIG. 19 is a detailed block flowchart showing one embodiment of the IP docketing application in further detail.

FIG. 20 is a continuation of the detailed flow diagram of one embodiment of the docketing application.

FIG. 21 is a detailed diagram showing one embodiment of an IP analyzer, according to the present invention.

FIG. 22 is a continuation of the IP analyzer diagram.

FIG. 23 is a flow diagram showing the remaining elements of the one embodiment of the IP analyzer.

FIG. 24 illustrates a block diagram of an alternative computer of a type suitable for carrying out the present invention.

### DETAILED DESCRIPTION OF THE INVENTION

The following detailed description includes many specific details. The inclusion of such details is for the purpose of illustration only and should not be understood to limit the invention. Throughout this discussion, similar elements are referred to by similar numbers in the various figures, for ease of reference. In addition, features in one embodiment may be combined with features in other embodiments of the invention.

IP information regarding intellectual property information by a customer, IP service provider, government entity or other source has been collected. Likely such information is extracted and deposited into one or more databases. Ultimately at least a portion of such IP information is presented to an end user on behalf of a customer, such as via an IP application, which may be executing locally, or via a web site over the World Wide Web, i.e., the Internet. For ease of description, such a collection of information will be referred to herein as “database”, although it should be recognized that the information might collected in other formats as well, and/or that an IP application might not be restricted to data stored in a database.

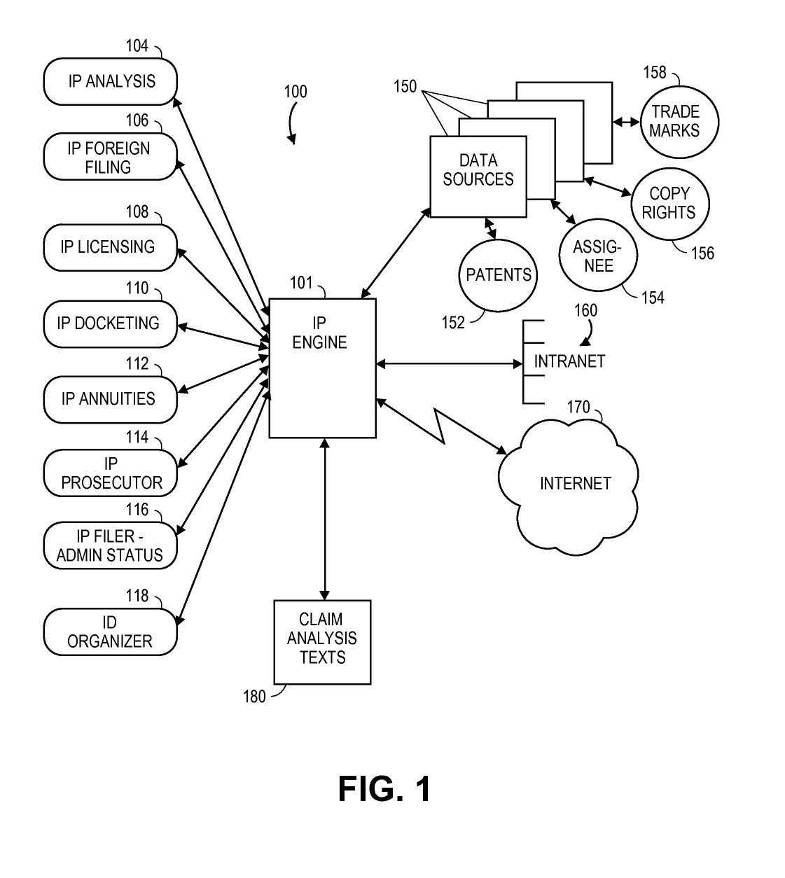

Reference is made to FIG. 1, illustrating a block diagram of one example of an intellectual property (IP) engine 101 for use in connection with the present invention and with several IP applications 104-118. Information in the one or more of the applications corresponds to one or more commonalities between the information in the other applications, illustrated by the following example. Consider that a user's engine is used in connection with, e.g. an IP licensing application 108. At least some information relevant to intellectual property has been populated in the licensing application. This information would relate to, e.g. the docketing application 110, as a portion of the information would be shared.

The commonality in this example system may be that the IP information is product-centric, and/or services-centric. For many companies, or concerns, everything they sell is tied to a product or a service; conceptually there is nothing in between. In their world of commerce, there are products and there are services. However, other shared attribute(s) and/or feature(s) may be used in addition to or as an alternative thereto, throughout the system and/or between two or more applications. For example, some users may find some IP attribute preferable to use as a commonality. As another example, some users may find a client/customer attribute most preferable for use as a commonality. Hence, a commonality that is used may be representative of an IP attribute that may (or may not) be present in one or more of the systems, and/or it may be representative of a logical attribute (e.g., product/service, client, that may (or may not) be present in one or more of the systems.

Although one attribute that may be common across IP is that it either relates to a product(s) and/or service(s), other common traits or data may also be noted. Once one is able to group IP, e.g., patents, and label the IP, e.g., patents as being related to one or more commonality, then that piece of information as labeled may be used across one or more applications. Referring to the product/services commonality example, once there is a product grouping one can identify the patent(s) and/or other intellectual property associated with the product grouping. If one looks at the patent, one may look up the product grouping. For example, what product is the patent associated with, what services does the patent cover? Because one may sort by the product/services labels from an application, e.g., the analyzer, one may identify relevant patents very easily, very quickly.

One may sort across one or more, as desired, of these tags or labels (commonalities). The name of the tag or label will inform the user in the generic sense what it is (e.g., product/service). Then the user may search further and further into the products, into actual applications, and further into components that comprise the products, to identify the relevant patents. The system is going down to an atomistic level of linkages of the patents (or other IP) corresponding to one or more selected or group components of the one or more selected products. There can be any number of levels; links can be included on one or more levels. A user could select not only the product, but also more specifically a particular model.

Once the user is able to do ascribe a commonality between applications, then the user can quickly jump to, e.g., performing an IP analysis on a product. In connection with the IP analysis, the user would see a particular patent, and e.g., performing the analysis. From these, their user could quickly jump to, e.g., the licensing application to see if there is anything relating to the licensing of this patent. For example, consider that there may be an ongoing licensing negotiation with some entity. If the user pulls up the patent information, the user will see the assignee. From there, the user could, if desired, enter the licensee's name as an assignee name for use as a search term in the database, and perform other relevant queries such as to see if there are other on-going licensing negotiations.

As time passes and as the system is used, the history and information continues to populate the databases. Alternatively, databases may be populated via a data ingestion process.

A user may wish to analyze a patent from the perspective that the user (or user's client) owns the patent. In this example, the user performs the analysis, and says that the patent relates to a particular component in a product. This might be a very important product line for you, the user (or user's client). The user may select the component, and then may request to see all patents associated with this component. In this example, the search return two patents, one of which is a continuation-in-part of the other.

Then the user may expand the search to request all patents associated with this product, not just that component. The search results return the patents relevant to that product. By process of elimination a user can determine which of the patents are the most important ones from the user's perspective for this particular product. Subsequently, the user may submit a query for one or more of the patents, for example, where we foreign filed? The system would return search results indicating the countries in which the desire or selected patents were filed.

The next query might be, for example, determining the cost of foreign filing a particular patent. Consider for example that the patent application in question was just recently filed; now that the user knows that this particular patent is of interest, the user may want to know how much it would cost to foreign file this? Assume for example that the user is the foreign filing manager, and has just been informed that this is an important patent, which should be filed in many important relevant countries as possible, but all within a budget limitation of $100,000. The user would proceed to select the IP foreign filer, select the patent, select the countries of interest, select the preferred associate in each country selected, select the patent application of interest that's in available, e.g., in a database already, and instruct the system to “go.” The system performs the relevant calculations to determine the estimate, such as depending on country valid counting the number of pages, number of claims, etc. This may advantageously be implemented in XML format. The system returns an estimate; preferably, the estimate corresponds precisely to an exact invoice that the user would receive from that particular associate, if the foreign filing occurs within the next few days, due to currency fluctuations. In this example, the user receives an exact estimate. He is $50,000 over budget, so the user obtains a detailed report; the user may determine from the detail report that if a few of these countries were eliminated, then the project will be within budget. So the user de-selects those countries, estimates again, and in this example the revised estimate comes out to $99,995.95. If the user wishes to file promptly, all he has to do is “click” the appropriate button, and electronically the application, information and request for filing are directed to the selected destinations.

In one or more embodiments, information is stored regarding each country, including parameters for determining the official cost of a filing; and/or information is stored regarding attorneys and agents, including parameters for determining their usual cost for filing, and contact information, including preferably electronic contact information. Default and/or averages information could be provided in addition to or instead of the above.

In accordance with one or more embodiments of the invention, one or more aspects of the invention may be made available a through Web portal. If such a web path is provided, it may be provided with physical and/or electronic security, e.g., passwords firewalls, etc. Users may log in to a closed, secure, BPM type level system. Accordingly, when a users accesses or logs, in to use, e.g., the foreign filing application, the portal, for example is a convenient way to provide accurate numbers subject to change because of for example the currency rate fluctuations. Further, associates' and/or agents' fees will vary over time.

An optional feature of the invention provides that the estimated invoice is binding on associates and/or agents and/or firms that have agreed to be members of the IP portal feature. E.g., if that patent application is filed under an estimated invoice within the certain period of time, they will honor that invoice. Hence, an accurate budget may be developed in connection with foreign filing. Conventionally, a user really does not know how much a filing is going to cost. An imprecise estimate may be provided, but the actual cost may be e.g., plus or minus 30, 40, 50% of the original estimate (usually plus). Hence, one or more aspects of the present invention provide exactitude to the system.

Other features may be provided to interact with, analyze, search, manipulate and/or use, etc. the IP information and information in the related databases. For example, now that the user has filed the application, what he may want to do is the docketing. If the system includes a docketing application with an automated docketing feature, the system may automatically take care of such docketing. As another example, if the system includes an analyzer feature, and if a competitor introduces a product on the market, or is about to introduce a product on the market, the user may want to start an analysis of the competitor product, e.g., against the user's filed patent application(s).

By providing one or more commonalities, which may be user-defined, e.g., labels or categories, a user may sort through whatever label and/or category is desired. For a user with a product- or service-oriented viewpoint, the most used commonalities may be the product or service. Once a user has requested an initial action (e.g., a search) from an IP application, he may begin drilling down from the original results using the commonalities. Linking and/or other user interface techniques provide a way to access further information, via the commonalities, so as to enable searches to follow a user's needs/wants. For example, there may be times when a patent is relevant to more than one product category or label. Consider the example of a broad chemical patent that is relevant to wholly different product lines. “Dye” may be relevant to product lines including clothing, food, hair care products, finished leather goods, etc. If the chemical company makes dyes without restrictions as to end product, and if it has a wide variety of product lines for numerous applications, a dye patent may be relevant to most or all company products. In this instance, a user might input a query into the system specifying one of the commonalities, e.g., “dye for clothing” as a product. Such a query would be received, e.g., by the IP engine. The IP engine would access the relevant commonality data, which would be correlated to one or more IP applications, such as the IP docketing application and the IP prosecutor application, and/or the database used by such IP applications. The docketing application and the IP prosecutor application would then generate respective reports, e.g., a summary of one of their usual reports, listing patents that correspond to the specified commonality data. By selecting IP docketing patent data, the user could drill down, e.g., via the IP docketing application, to determine the status of the patent applications relating to “dye for clothing.” On the other hand, by selecting the IP prosecutor application data, the user could drill down to the application as filed (and/or amended), retrieve and review the application, and determine for example whether the patent applications relating to “dye for clothing” include relevant claims.

According to one or more embodiments of the present invention, the user could perform further actions based on the indicated commonality/commonalities and/or based on information retrieved by the IP application. Continuing with the clothing dye example, one could select certain of the patent applications claiming “dye for clothing”, and retrieve information having a commonality with the selected patent applications from the IP applications included with the user's system, e.g., an IP licensing application. Such a retrieval would return those licenses having a commonality with the selected patent applications. The user could then, if desired, drill down to the indicated licenses. And the further actions could continue, with the user bridging from one IP application to another. A user interface could be utilized, if desired, with the IP engine so that interaction with the user's system appears to be a seamless, integrated IP system.

Similarly, IP data is a quality or characteristic corresponding to one or more products and/or services, just like a “component” may be a quality or characteristic of one or more products and/or services. IP data and/or other qualities and characteristics may be utilized, if preferred, as one of the commonalities. According to one or more embodiments of the invention, and/or other included features, IP data is but another characteristic of a product or service. One optional aspect of the invention has shifted the perspective from IP data as a commonality to focus on the product and/or service.

Similarly, work product may be assigned a commonality, and a database of work product can be utilized in connection with one or more embodiments of the present invention. For example, claim analysis that a company may be bringing to bear on its main line of business could be stored in a data base together with one or more commonalities (e.g., IP data, product/service type). When used in combination with the IP system of the present invention, a user may retrieve the work product as well as other data from other IP applications, and review or follow the data from various perspectives utilizing the commonalities. Any item entered in any of the database may have one or more commonalities associated with it. The commonality information may be directly stored in the IP application database together with the IP application data items, or may be indirectly associated with the IP application database e.g., as a separately stored index of commonalities into one or more IP application databases.

A user may progress through one or more included IP applications included in the user's system, to obtain desired information from the various IP applications, related to one or more specified patents, and/or that may be associated with that commonality (e.g., product and/or service). The user may generate one or more reports displayed the retrieval information. The reports may be the usual comprehensive reports obtained from one or more IP applications; alternatively, according to one or more embodiments of the present invention, the invention presents the reports in a consistent format. Preferably, the reports are provided in real time, reflecting current data in the system. (This is a large advantage in comparison to asking one's lawyer to provide a report, which report may be provided outdated a month later.) Such user could be an individual, or may be an entity using the system on behalf of a company, or a law firm or any entity.

The lawyers or agents or staff who would interface with these systems to update the documents and status, instead of receiving output from the system, e.g., reports, as pages of paper documents, may be paperless to the extent desired. Moreover, if a company has several outside lawyers doing patent work for it, then the company may want all of the outside patent counsel to access the company's system so that information is captured and made available and is less prone to manually-created errors. For example, if the system includes a docketing application, then it will be easy for in-house personnel to perform certain tasks while the rest of the tasks are preformed by outside counsel who are equally connected to the company's docketing application.

If prosecution is still being handled at least in part by mail, then according to one or more embodiments of the application, preferably the mail (such as the official correspondence) includes an electronic label, barcode, or other electronically cognizable identifier. Anytime a piece of mail is received, users are able then to take the mail and then electronically identify the type of mail. Information that might not be electronically cognizable may be manually entered, e.g. the type of action (rejection, restriction, etc.) Because one is performing this automatically as the mail is done, it does not require the extensive traditional docketing department in determining what should be docketed. Taken to its logical conclusion, the patent office(s) and patent filers will utilize a consistent series of codes for the different types of actions, where the codes are electronically cognizable.

According to one or more embodiments of the application, correspondence for prosecution could be distributed electronically such as via e-mail. This presents similar issues as the mail discussed above. If the Patent Office is using this system, then the computers may automatically prepare and/or transmit communications to each other.

According to one or more embodiments of the application, the IP prosecutor application includes the ability to automatically generate responses, documents and/or response templates. The attorneys would add substance in the automated documents that the system is generating in response and/or review the generated documents for accuracy. For example, when an office action comes in on a particular case, according to one or more embodiments of the present invention, the optional prosecution feature may automatically produce an amendment form, in response to the office action date mailed on a particular date, leaving a space for the attorney to prepare a substantive response, e.g., amendments, arguments. According to one or more embodiments of the IP prosecutor application, claim amendments of the format prescribed by the Patent and Trademark Office could be automated. The IP prosecutor application then automatically compares the original with the amended claim and prepares appropriate attachments as required, e.g., a clean claim and a mark-up claim with underlines and brackets.

This system with one or more applications shows the user the data, sources of communication, reports, etc.

The various different commonalities may be provided, e.g. as a default. Preferably, a company or user may customize the commonalities used by the system. Note that a system may use one or more commonalities. According to one or more alternatives, customizations may be locked, i.e. indicated as unchangeable except by an authorized user.

FIG. 1 is an overview block diagram illustrating the organization and structure of an IP system for use in connection with one or more embodiments of the present invention. As shown, a suite of IP applications 104-118 are provided, covering a variety of functions, tools and methods, for use in connection with an integrated IP system 100. The system 100 incorporates an IP engine 101. The IP engine 101 may communicate with other computers via, e.g., a central data communications channel, which may include available hardware and software communications elements (e.g., a network pipe comprising cable, routers, busses through which multiple servers are connected to support an ASP environment; a bus internal to a mainframe computer). The IP engine 101 may be operating, for example, on a general purpose computer, a server, a personal computer, or on any other appropriate computer. The IP engine 101 communicates directly or indirectly with data sources 150, one or more intranets 160, the Internet 170, and/or other IP related information, e.g., claim analysis texts 180. According to one or more embodiments, the computer on which the IP engine 101 executes may also host or communicate with one or more IP application programs 104-118. In accordance with one or more embodiments of the present invention, the IP engine 101 may be used in connection with communication ports to accommodate or communicate with the databases 150. The IP engine may communicate with users and/or application programs and/or other databases and/or other IP engines via, e.g., the Internet 170, which may include separately addressable website functions, one or more Intranets 160, an Extranet (not illustrated), or some other form of portal through which Internet/Intranet and other internal local area network features and functions become available to the user.

Certain aspects of the IP system 100 in connection with which the present invention may be used include a grouping of one or more IP applications 104-118. The one or more applications each individually provide functional capabilities to the client, to the client's customers, to the public, to vendors, or to other users. Each of these functional capabilities provides stand-alone capability for the discrete needs of the user. In accordance with one or more features of the present invention, the functional capabilities of the discrete applications are coordinated so that a user may build on functional capabilities offered by discrete applications. Accordingly, the data created/retrieved/accessed and/or stored by one functional application may be utilized by another, thereby providing greater analytical possibilities that may supplement and complement each discrete function. For example, the docketing function 110 logically may support and complement the prosecution function 114. Data from these two applications can be used by the analyzer application 102, and vice versa. A brief overview of the functions of example applications are recited below, followed by a description of the communication between the IP engine 101 and the applications and/or their data.

In accordance with one or more optional embodiments of the present invention, there may be provided the IP analyzer application 104. This is an analysis tool, preferably provided on-line, intended to help the user better manage IP portfolios, whether trademark, copyright, patent, or otherwise. In accordance with one or more embodiments of the present invention, the IP analyzer application 104 may include its ability to identify and categorize different forms of IP, and/or its ability to correlate IP with products, including but not limited to patent claims with actual products that are either owned or under development as well as to correlate those claim sets with competitor products or competitor services. Such identification may be accomplished, such as by searching the database for keywords, or manually, such as by prompting a user to assign values, etc. A further optional feature of the IP analyzer application 104 is its ability to be used in connection with performance of IP validity, clearance and infringement analyses that are useful in the development of intellectual property opinions. The IP analyzer application 104 may generate an initial patent claim analysis, by breaking down claims into constituent elements, identifying key words in claim elements, searching the patent specification for the keywords, and populating the claim analysis for each element with reference to the preliminarily determined relevant section of the specification. The IP analyzer application 104 may be applied to other areas of IP including trademarks, copyrights, trade secrets, patents, and/or know-how, etc. Moreover, the results generated by the IP analyzer application 104 may be used in connection with other IP applications. Moreover, it is anticipated that the IP analyzer application 104 may be used in other fields where the synthesis of disparate data, law, rules and opinions by a single tool provides significant advantages and efficiencies to the IP professional.

The optional IP foreign filing application 106 is an application that is intended to assist the IP professional in filing various types of IP applications throughout the world. The IP foreign filing application 106 assists the user in filing applications outside the home country, or based on another filing, e.g., non-convention patent applications, Paris Convention patent applications, Patent Cooperation Treaty (PCT) patent applications, trademarks (US and foreign), copyrights, and sui generis protection schemes. The IP foreign filing application may be used for automating the filing of trademark applications in the Unites States, overseas and convention applications. In addition, the IP filer helps the user file non-convention and Madrid protocol applications. Due to the complexities of worldwide filing, and the disparate forms of IP that are registrable, other types of intellectual property filings may be available through the IP foreign filing application 106. Those other types of intellectual property filings include, but are not limited to, statutory invention registration filings (US), copyright registration applications (US), semi-conductor mask registration applications (US), and utility model registrations (Europe). The IP foreign filing application 106 may rely on other applications that provide intellectual property data. For example, the IP docketing application 110 may provide data relating to filing deadlines. The present invention, including an IP application such as the IP foreign filing application 106, may be designed to accommodate a variety of databases, e.g., an open database architecture (ODBA). And, while the IP docketing application may operate more seamlessly with the IP foreign filing application 106, neither is a necessary component of the present invention.

Another application that may optionally be included in the integrated system 100 is the IP licenser application 108. The IP licenser application 108 is intended to assist the user in organizing, tracking, storing, searching, retrieving, and/or leveraging license agreements. According to one or more embodiments of the present invention, the licenses may be stored in a searchable database, and accessed by the IP licenser application 108. Preferably, the licenser application 108 includes a feature permitting it to record and maintains license negotiation histories, as well as to store information about the license agreements themselves. According to a preferred embodiment, the IP licensor application stores a record of license negotiations, whether originating as electronic mail, or as a recorded telephone discussion, etc. Hence, the IP licensor application advantageously may be designed to store licensing information in a multi-media database. Optional features that the IP licenser application 108 may include are real-time annotations of license agreements, video/audio recordings of the negotiations of those documents, photographs embedded into the licenses, digitized images of the license agreements, and affiliated correspondence and exhibits.

According to one or more embodiments of the present invention, there is provided an IP docketing application 110. The IP docketing application 110 is intended to provide the user with information for managing and scheduling all prosecution duties relating to patents, trademarks and/or copyrights. It is in essence a master scheduler, a tool containing or referencing rules that determine various time periods, an information distributor that provides email, and/or a network-driven messaging tool on a local and/or distributed platform. The IP docketing application 110 output can be used as a source of data for, or to trigger as appropriate, one or more of the other IP applications 104-118, illustrated for example in FIG. 1.

One or more embodiments of the present invention may provide an IP annuity application 112. The IP annuity application is intended to manage the maintenance of intellectual properties. Accordingly, the IP annuity application 112 is designed to provide the IP professional with patent, trademark, and in some instances, copyright maintenance and annuity fees calculator. A further optional aspect is the maintenance scheduler from which maintenance deadlines derive. Similarly, the IP annuity application 112 may provide a trademark renewal schedule maker.

The IP prosecutor application 114 may be provided in accordance with one or more embodiments of the present invention. The IP prosecutor application 114 enables a user to generate forms and other documents that are used in connection with the prosecution of patents, trademarks and copyrights through various government offices. In addition to being a form-oriented system, data from the IP docketing application 110 may optionally be retrieved by the IP prosecutor application, optionally via the IP engine, and used in connection with generating forms fully filled out with docket information on a date-sensitive and time-sensitive standpoint. As a result, a user may be provided with prosecution documents on a timely basis well in advance of a pending deadline. In addition to the prosecution functions, the prosecutor application 114 may contain features such as an on-line notary service and foreign patent prosecution forms. The IP prosecutor application 114 may, optionally, include forms for other areas of intellectual properties including copyright registrations, PCT forms, trademark forms and other analogous supporting material that is required to successfully prosecute IP before the relevant governmental patent, trademark or copyright offices (where registration and/or examination is required).

The IP organizer application 118 may be provided, in accordance with one or more embodiments of the present invention. The IP organizer application 118 is intended to provide a function, which can either be a subscription based on-line research tool, or a packaged tool that may be loaded into a user's computer. The IP organizer application 118 is intended to give a user tools with the capabilities to search for, retrieve, and/or organize patents and their associated images. The IP organizer application 118 optionally may accommodate not only US patents but also patents from throughout the world. Additionally, the IP organizer application database may include foreign patents, copyrights and trademark data, and/or images associated with those intellectual property documents. Optionally, the IP organizer application 118 may include features such as a patent alert service and batch downloads of patents uncovered in a patent search.

The power and elegance of the IP system 100 may be demonstrated by its ability to synthesize a substantial quantity of different data, often coming from different sources, in order to maximize the analytical power of the functions 104-118 individually and collectively. In the illustrated example system, a variety of public data sources and private data sources are available to the IP system 100, such as through the communications port 150. The data sources may include publicly available data, e.g., the US Patent and Trademark Office collection of on-line patents 152, the classification index for those patents, the collection of copyrights provided by the US Copyright Office, and/or the public trademark database; privately available data, e.g., proprietary databases made available to third parties such as via subscription; and corporate data, e.g., information generated by and/or confidential to a corporate entity. Corporate information may be connected to the communications port. Corporate information may include, e.g., information representative of company-owned patents and applications collected on the private database side of the collection. In addition to the wealth of data resources that may advantageously be used by the present invention, the IP system 100 may be connectable to an Intranet 160. Similarly, an Extranet can also provide information to the IP system 100 and its assemblage of IP applications 104-118.

Another resource for data is the Internet 170. If preferred, connection to the Internet may be made through a secure server that, in turn, connects directly to Internet backbone or an Internet service provider (ISP). According to one or more embodiments of the present invention, information may be supplied by one or more known databases that contain competitive information. Note that the various IP applications may include other features, e.g., the IP docketer application 110 may include a competitor watch feature, which in turn, may be yet another source of data for use by the IP system 100.

A further resource for information, included in one or more embodiments of the application, is the claims analysis texts 180. Claims data may be broken down, analyzed, and the analysis text stored and tied to other aspects of the patents at issue. The claims analysis texts 180 are illustrative of other potential sources of information that may be used in connection with the IP engine 101 in order to provide a rich environment for the IP user. For example, the claims analysis texts 180 may be used by several of the applications including the IP analyzer application 104, IP organizer application 118, and/or the IP prosecutor application 114.

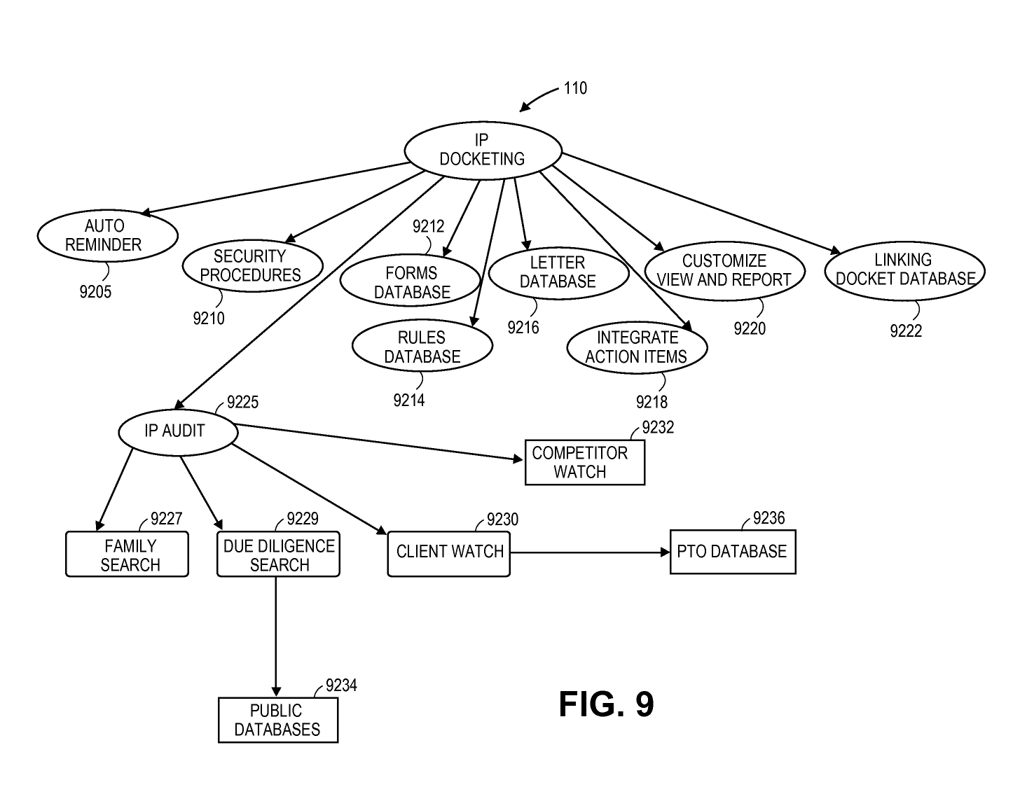

FIG. 9 is a block diagram illustrating the IP docketing function 110 and sub elements making up that function.

A key aspect of a comprehensive docketing application 110 is its reliance and intelligent synthesis of multiple data sources. The sources support standard docketing functions (e.g., deadline, status, patent serial number, trademark serial number, copyright registration or control numbers). These data also add a wealth of information that is transported into the function being performed by the docketing system. Ultimately, the data is taken out of the docketing system for use in other parts of the IP product. Moreover, the IP docketing function 110 is designed so that all intellectual property personnel in a given network environment may have access to docketing.

The IP docketing application 110 that optionally is used in connection with the present invention may optionally be derived from the design philosophy that all data storage techniques are scaleable. An IP docketing application designed according to scalable design will provide wide accessibility of docketing information (with appropriate security levels built-in) so as to insure that the maximum amount of information is disseminated, received and developed by users of the system. A further optional feature of the IP docketing application 110 is that it may integrate with other IP applications, e.g., via the IP engine 101, such as to the IP licensing application 108, the IP prosecutor application 114, and the IP analyzer application 104. By providing this overlap between functions, the richness of the IP docketing application 110 can be fully realized. For example, if a patent prosecution item concerns an extension deadline that is necessary in order to respond to an outstanding office action, an option is available to retrieve and pre-fill an appropriate petition for extension of time form to be filed with the response to the office action. Hence, data presented from the docketing system optionally will be sent outward to the IP prosecutor application 114, where that information may be used to fill out the form and the response.

Once the filing is performed through the IP filer application 116, that information may be presented back to the IP docketing application 110 for an automated update. An extensive collection of forms as well as reporting letters may be made available. In particular, the IP docketing application 110 may be realized on a form database that contains updated forms which relate to the docketing function. This does not merely mean that the forms database consists purely of US Patent prosecution forms; it may include foreign filing forms, and/or international convention forms (PCT, EPO, OAPI). Further, forms tangentially relevant to prosecution and docketing may be included. For example, the forms database may include forms for filing state name registrations, forms for recording purchase money security interests, and/or assignment forms for patent, trademark and/or copyrights, etc. An optional database of letters typically used in connection with prosecution forms may provide a combination of forms and addresses associated with a particular docket. For example, if the aforementioned office action has been completed, the letter database may be accessed, preferably automatically, by the IP docketer application 110 in order to generate a form report letter. That form letter may include database-driven information, e.g., client, docket number, and/or substantive information relevant to the office action at hand.

FIG. 9 illustrates one embodiment of the IP docketing application 110, with several features: auto reminder 9205, security procedures 9210, forms database 9212, rules database 9214, letter database 9216, integrate action items 9218, customer view & report 9220, linking docket dates 9222, and IP audit 9225. Although the present example illustrates several features, other embodiments may include a combination of less than all these features and/or other features. Since a variety of personnel may have access to the IP docketing application 110, the IP docketing application preferably includes security procedures 9210, which may be provided for example by a security application. The security application partitions docketing information only to appropriate parties. At its highest level, a user will be able not only to access docketing information but also modify, delete, and update docketing data along with the other databases that tie into docketing. At a lower level of security, a user will only have the right to add new docketing information or change records pertaining specifically to docketing. Thus, that user would be able to update a case to indicate that there has been an office action, or to add a new patent, copyright or trademark application to the database. However, that level of security will not enable the user to modify forms in the forms database, or change client information in the letter database. According to one or more embodiments of the present invention, any level of security is enabled to be user-definable by the system administrator at the highest level. Thus, it is possible that the second or third level user in the security scheme can modify client information in the letter database but not change forms or any alternatives. Security partitioning may include a read-only layer and/or a layer that is designed for use by users outside the firewall. For example, the IP docketing application 110 may reside on an Intranet as well as an Extranet for a portal. Thus, Internet security procedures may be employed levels of access to data off of a public Internet page.

According to one or more embodiments of the present invention, the security may implicate the security of information itself. Security procedures may incorporate standard security technology in order to assure that the transferred information is accomplished without interruption or destruction and/or that the transfer is directed to an authorized party. Standard security software such as SSL (available through Verisign, Inc. or others) is appropriate for use as a part of the security procedure application. A optional aspect of the security procedure application may be that the data itself may be blocked or partially blocked depending upon who is accessing the docketing system. For example, very frequently a docketing clerk will be asked to provide a report so that non-client parties are interested in finding out the status of intellectual property belonging to an entity. As a result, it may be critical to block out certain information that is confidential. For example, serial numbers are kept secret until published by the US Patent and Trademark Office. Other information such as copyright deposits may also be maintained as trade secrets during the term of the copyright. Thus, the security procedures may be customized to maintain the trade secrets status of a variety of information contained within the docketing application and its database. Security procedures may be applied to other aspects of the present invention, e.g., one or more other applications.

According to one or more embodiments of the present invention, a database 9220 from which information may be drawn is a customized view and report file. This data source enables personnel having access to the docket to create and utilize custom views and reports so they can see docketing information in a user-friendly fashion, on a real-time basis. Customized view and report information may be linked to a client database so that particular reports can be designed to suit one or more customers' needs. For example, certain customers might want to see docketing information presented and reported in a certain way. Some clients, for example, like to have reporting letters sent from the letter database incorporating within them debit note bills (rather than the monthly bills). By linking the customized report and letter databases with the client information provided by the IP docketing application 110, debit note billing can be accomplished automatically without operator intervention.

A further optional capability of the customized view and report feature is that it allows IP or other personnel to publish a docketing report, such as through the Intranet 160 or over the Internet 170. This can be a very powerful function. For example, if the docketing system is implemented as an ASP, rather than in-house, then reports may be generated and made available through an Internet website to multiple parties accessing the ASP website. Thus, the client, the attorneys (managing attorney and associates), customers and investors of that client may have levels of security to the same data and to have that information reported automatically. This network of users may be expanded when foreign docketing is considered. For example, if an office action is received from a foreign patent office, then the US attorney, the foreign attorney, the client, and other interested parties may be notified. The network of users receiving automated information may include entities such as licensees (e.g., for notifications), annuity payment companies, sub-licensees, investors, and/or any other parties designated by the client or attorney or other appropriate user.

A further feature added to the reporting function may be the automatic reminder 9205. Presently, many Internet and computer-related hardware and software systems are designed to work closely with client email calendaring and addressing software, predominately a Microsoft Outlook program. An additional optional feature of the IP docketing system 110 may be contained within an automatic reminding capability that works directly with an IP professional. As a result, office action deadlines and reminders may be integrated directly into a user's calendar or email sub-system. A user that operates on an IP system with an IP docketing application may be notified through email of an impending docket date. The reminder message may include the substance of the task that must be done. The user may be provided, e.g., through email, with the one or more forms correlating to a task, which may be filled out to complete the task. Since the auto reminding function is not necessarily relegated only to the attorney listed in the docketing system, the security layers may be used to be filter information for consumption outside of the law firm or corporate law department. Co-inventors may receive automatic reminders of due dates, receive automatic distribution of information pertaining to those due dates, and/or share in the drafting of the amendment being prepared by their counsel. The result is an IP docketing application 110 that integrates interested users and integrates the information across those users who have different roles in responding to the due date.

In order to effect docketing properly, the most current rules should be accessible by the system. Hence, a rule database 9214 may be included to provide continuous updates as well as a frame of reference for the practitioner, the docketing person, and the client. The rule database contains all sources of patents, trademarks, copyrights and other docketing related rules. Those sources include a copy of the US Code, the Code of Federal Regulations, the Manual of Patent Examining Procedures, Trademark Examining Procedures, the Copyright Compendium of Practice, rules relating to the Patent Cooperation Treaty, information pertaining to the various intellectual property conventions including the Paris convention, the Berne Copyright Treaty, and notices of published patents and trademarks appearing in the Official Gazette of the United States Patent and Trademark Office. The rules may be utilized in other ways as well. One alternative approach is to replicate the rules as they are found in the publications. Another alternative approach is to link each rule to the functional aspects of the docketing database software so that the rules are tied directly or indirectly to action items. The rules may include a comment or help field to be provided to the user. The user optionally may refer to the help menu, and/or may immediately relate the relevant rules to the forms and the docketing deadlines provided by the docketing software. Optionally, the rules database may provide access to other resources, e.g., linkages to Internet and/or Intranet and/or electronic resources, for commentary and explanation of the rules as well as interpretation of those rules by various courts and administrative bodies. The interpretive feature can be particularly desirable for certain users, particularly when making a substantive analysis such as occurs when responding to intellectual property office actions. For example, a display of a prior art based rejection under the non-obviousness standard (35 USC §103) may be accompanied by a screen which references element holdings of the seminal cases relating to the obviousness standard. The optional rules database 9214 may include one or more search engines that enable the user to uncover those rules that appear to be most relevant. Optionally, integrated access may be provided to manuals (electronic or otherwise) allowing classification of goods/services, such as versions of the International Tariff Codes that allow for the standardization and classification of goods. Personnel can thus share a reference for use in creating custom commonalities, such as variations on standard goods for future incorporation into trademark records.

It should be noted that each record may optionally be designed to have commonality data associated with the docketing record. The record can be linked to a commonality such as a specific product through, for example, an SKU model number and/or a manufacturer batch number (if relevant). The IP docketing system 110 may optionally include an action item integration function 9218. This function allows for the integration of various action deadlines and reminders to work with the other reminder functions. It also allows for the integration of a variety of phases related to the patent application. For example, the action item function includes fields that are appropriate for patentability searches, validity search requests, infringement search requests, invention disclosure statements, patent applications, patent publications, and granted patents. By use of the integrate action feature 9218, a wizard may be assigned to each case which queries and directs the user to take specific actions with regard to their particular docketed item. The function can also be tied to other forms of IP including trademarks and copyrights.

One of the optional features of the docketing system 110 is the IP audit function 9225. The optional IP audit function 9225 performs various audits. One optional audit is performed by accessing the rule database 9214 checking for potential oversights that may result in significant loss of rights of the client and a potential malpractice suit for the practitioner. For example, one of the optional features of the IP audit is to sift across multiple cases that are related to insure certain actions have been taken. Docketing systems frequently fail to warn the owner of an originally filed patent application that it must pay the maintenance fees of a reissue case even though the reissue application is currently pending. If the original application is not on the system, the firm is responsible for payment of maintenance while the reissue is pending. Typically most existing docketing systems will not trigger a reissue maintenance deadline. Failure to pay the maintenance fee on the original application will cause the reissue application to become abandoned. Likewise, conventional docketing systems do not recognize that after issuance of a reissue application, maintenance fees need only be placed in an inactive status to avoid double payment. The rules database, coupled with other databases including the auto-reminder, insures that under an IP audit, failures like these are caught and removed from docketing.

According to one or more embodiments of the present intention, the IP docketing application may include the ability to automatically hyperlink a generated document date with the appropriate Internet site containing information relating to that deadline. Accordingly, an automatically generated deadline from the IP docketing application 110 may refer to, for example, treatise conventions from the Internet. Those conventions may be hyperlinked or otherwise connected to the relevant portion of the treatise supporting the calculation of the particular deadline. Further linked information may include foreign annuity and/or deadline dates; these optionally are linked to the foreign statute supporting the calculation, citations to the CFR and MPEP sections relevant to the action. These sources of information may be linked to the IP analysis application. Furthermore, the IP docketing application 110 may include enhanced visualization tools, such as Excel charts and spreadsheets that may be automatically generated based on metric reports from the IP docketing application (number of applications filed by a particular associate, by client, by department, etc.).

The optional IP docketing application 110 may include publishing tools to allow restricted access to certain fields, reports, records, etc. For example, a docketing client which happens to be a large intellectual property law firm may provide web access through a secure server to individual clients to docketing information based on criteria selected by that law firm. As a result, the number of non-billable reporting duties for docketing personnel and large intellectual property law firms will dramatically drop. This is because docketing personnel frequently spend a significant portion of their day (for example, in excess of 30%) generating non-billable reports for clients based on docketing data. The docketing function optionally may include related services such as a patent family search 9227, an IP due diligence search 9229 (e.g., of public databases 9234), a client watch 9230 and/or a competitor watch 9232. Each of these provides information that is relevant to docketing, yet is not directly related to docketing. These related services may be included in the IP system, e.g., as part of the IP audit feature 9225. Specifically, clients may request a docketing audit on the entire docketing database or on a sub-set of that database (e.g. by type of IP). The purpose of the IP audit is to identify potentially missing files, electronic records, office actions within a file, incorrect filed data (e.g., name of inventor, company address, foreign priority application number, etc.). The potentially missing information is usually identified by the user requesting an audit either within any of the applications or by sending a request via the website. Once that information is received, the system will automatically perform an Inpadoc or Derwent family search. The family search or searches are used to determine if correct priority and status information for all records (including foreign patent applications) should be grouped into the same family. The result of the searches is then sent to the requester in electronic form that allows that user to simply review each potentially missing record. The requestor then selects whether to place the record on hold, delete the record, or add the record to the docketing database. When large client portfolios are transferred from firm to firm, schedules are often out of date and incorrect. Moreover, the physical files may not be transferred correctly. Additionally, due to the instability of importing and exporting records between various publicly sold database-related docketing systems, few firms have attempted to electronically transfer data, even between identical docketing systems. If records are not added to the docketing system, annuities are often missed and applications are unintentionally abandoned. To this end, IP docketing audit is an invaluable tool. It insures the accuracy of the data contained in the docket while providing an extremely efficient automatic and electronic transfer of data from public on-line databases. The audit combined with the import applications from the other databases creates an unprecedented and powerful IP tool.

Similar to the family search capability 9227, the docketing system optionally may provide clients with a due diligence search capability 9229. Satisfying the due diligence function requires data and analysis in connection with leveraged buyouts, initial public offerings, and other forms of corporate deals that relate directly or indirectly to the IP assets. The electronic searches include automatic searching reports 9221 and analyses based on public databases. The public databases include corporate databases such as Edgar (SEC filings), intellectual properties databases, copyright office databases, US and foreign trademark databases, Derwent™, Inpadoc™, and the US Patent Office database (www.pto.gov), and assignment records. In accordance with one or more embodiments of the present invention, a litigation database may be analyzed, such as the Litalert™ intellectual property database.

The due diligence search 9229 may automatically compile the available on-line public information and puts it into an electronic project which is retained within the IP docketing application and the IP analysis application for future reference. A typical due diligence report may include, e.g., bibliographic data on the scope and nature of that data contained in each database, and/or a summary of that data. For example, a search for a company ABC includes the discovery of a European patent application, and that application has been, according to the European database, designated and validated by the German patent office. However, according to the Derwent and Inpadoc databases the application is not active in Germany, due to a failure to pay the annual annuity payment. This conflicting data preferably is included in the due diligence search report 9229 so that a user can investigate and determine the controlling facts. The user may optionally be able to request, through a foreign associate or by email, the status of the validation within the German patent office.

A further auditing feature according to one or more embodiments of the present invention is an automated audit of all granted records (US or foreign or international) included in the IP docketing application 110 and the full text download of that information into the IP analyzer application. Optionally, the user may request the client watch application to sweep databases for granted US patents and/or published foreign applications relevant to a client's product or services. Moreover, the data generated from client watch 9230 may be automatically integrated as a project into the IP docketing application 110, or other applications such as the IP analyzer application, for later use. For example, if a law firm only handles a small portion of a client's prosecution workload, that firm may nonetheless be interested in providing a client with reports based upon all the IP that have been filed, not just those patents, trademarks and copyrights filed through that particular firm. Moreover, the information generated by client watch 9230 would be useful to that law firm for purposes of analyzing IP coverage issues resulting from different firms handling different portions of the client's portfolios. The information can be used for developing IP strategies and also provide the client with reports of worldwide patent coverage. Other information can be integrated into the client watch including on-line projects pertaining to public data such as press releases, trade magazines and financial databases. Those public databases 9234 are also available for the due diligence search application 9229. The Patent and Trademark Office database of issued patents is likely to be relevant and may be accessed in the due diligence search feature.

A further function that can be found in the IP audit cluster is the competitor watch 9232. The competitor watch 9232 is similar to the client watch 9230 in that a customer can give a competitive advantage to its clients by providing frequent reports on competitor intellectual property activities. The data in the client watch function is not only restricted to granted US patents and published foreign applications for competitors but is broadly defined so that users can provide their patent clients with spreadsheets of trends, colored charts and visualizations relating to patent activity by competitor. The competitor watch database accesses public information (press releases, trade magazines, financial databases, news coverage) as well as the variety of standard intellectual property specific databases that come out of the due diligence search engine 9229. Company specific competitor information can also be easily categorized by the competitor watch function 9232 within the context of the project. It can be thus integrated in both the IP docketing application 110 and other applications, e.g., the IP analyzer application, through its output. An example of the power of competitor watch 9232 is as follows: A client can attend a trade show and retain specific data related to a patent, trademark, copyright or license search record in the docketing application 110. The client can also name that data as “product X” and tie it to a competitor's name within the IP analyzer application. Every time further information arises about “product X”, the integrated system allows instant access to an enterprise-wide knowledge base regardless of whether that client information is contained within the IP docketing application or the IP analysis application.

Another example involves inventors. Inventors frequently change companies. Those inventors carry with them important strategic information about their previous employer's business. This type of data can be retained within the IP docket and IP analysis systems. Thus, if an inventor is aware that a certain product line is being pursued, the IP docket system will contain annotations relating to the strategy within the context of the search record created (when, for example, an infringement or state-of-the art or trademark availability or invention patentability search is conducted). If that search then matures into a patent or trademark or other form of IP, and then an IP docketing record, those inventor-created annotations will be accessible despite the specific record relating to the invention. Thus, the record will probably mature into a product within the IP analyzer application. If products are utilized as a commonality, all patents related to that specific client commonality (i.e., the product) may be grouped and compared to competitor products/patents by computer watch 9232.

As previously noted, the IP docketing function may be implemented on a stand-alone basis, as part of a server to a local area network, as an ASP service or a public or private website available to users having different security clearances. As a result, the IP docketer application 110 may be made available on a site-license basis, as part of a monthly service package, and/or as a product with updates for both software and databases associated with that software.

According to one or more embodiments of the present invention, the system may be used cross platform. Cross platform may include time integration, time stamps or such in the exchanged information. The commonality feature allows the IP system readily to be used cross platform not only within the suite of IP applications, but also across other one or more features of the applications. In certain situations, a user may prefer to have fewer features than are available as part of the IP system. For example, a patent prosecution boutique law firm may only wish to use the IP rights analyzer, the licensing, the docketing, the form filer, and prosecution features. Further, they may simply use it relative to particular patent application numbers and applications, as opposed to products/services. The IP applications may be provided in a modular fashion, so that they may readily be included or excluded for use with the IP engine 101 and/or IP system 100.

The IP boutique, for example, or other user, may customize the IP system to sort by company, owner, and/or client/matter (as a commonality) instead of or in addition to product/services or other commonality. Entities using the system may share information if desired. E.g., a company could send its product/service data to an IP boutique. That company has already defined what its patents are linked with relative to product and services commonalities, and if a user wants its law firm to know that as well, the user may send that information along. Hence, according to one or more embodiments of the present invention, the company may have an option that allows an outside law firm to drill down to the product service level if they wanted to, or filter that out.

The present invention has been described principally in connection with patents; nevertheless, it also applies to trademarks, copyrights, trade secrets, designs, mask works, and other sui generis forms of intellectual property protection. Consider, for example, trademarks. One may query how many countries have are covered in connection with a particular trademark. The system would respond with applications/registrations in each country, and, optionally, the statuses of each. Further, if product/services groupings are used as a commonality in the docketing system and the inventory or licensing system, one may rapidly ascertain whether the company is selling trademarked product(s) in a country in which a trademark registration is up for renewal, for example. Hence one could rapidly determine whether or not a trademark may be renewed alleging current use.

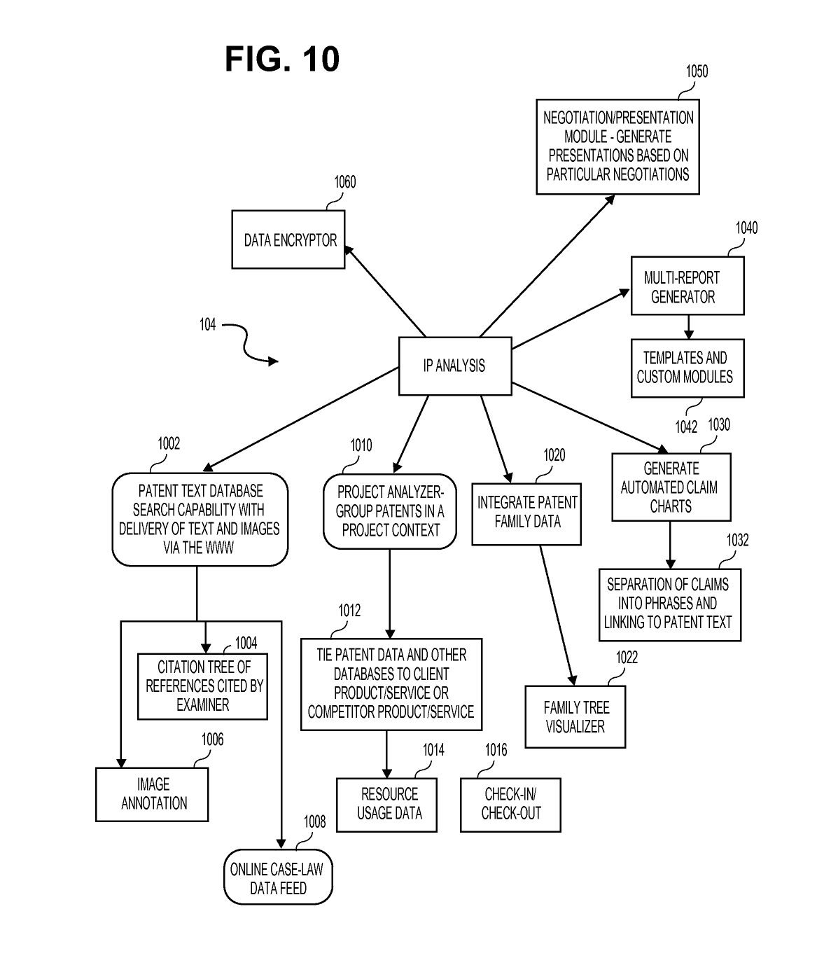

Referring now to FIG. 10, an overview block diagram of one embodiment of the IP analyzer application 104 is shown. The illustrated embodiment includes a number of features. These features, or a subset, and/or other features, may be included in other embodiments of the IP analyzer application. One optional feature of the IP analyzer application is a connection to the IP organizer application 118, illustrated in FIG. 1. Data produced by the IP organizer application may be relied upon by the IP analyzer application 104 in performing analysis on IP such as patents. That information can be made available to the IP analyzer vis-a-vis the Internet, an Intranet or Extranet, a local area network, or any conventionally known wide area network. In addition to U.S. patent applications, there is wide availability of other published IP, such as European patents, PCT published applications, trademarks, copyrights, etc. as well as any other related intellectual property information.

The IP analyzer application 104 is able to operate on the patent databases to perform a variety of important functions. One such optional function is the patent text database search capability 1002. Through the present embodiment, full text searching will be available for patents that are provided from the IP analyzer database. Another available search capability is natural language searching 1002 of patent data. As a part of this search function, the analyzer application 104 delivers patent text and images via the worldwide web, or any other network. A number of specific search tools may be included. For example, a citation analyzer 1004 may be provided as a tool for the user, enabling the user to visualize a tree that illustrates patents cited during a prosecution history. By accessing the analyzer, a user may span the tree and display up to, e.g., five generations of cited patents at a time. Users will also be able to traverse the tree and produce citation reports based upon user-defined criteria. For example, the user can identify a patent and request a report of the most often cited patents. The report can go back a number of generations (including inventors and assignees). For example, the first generation of the report lists all patents cited during patent A and B's prosecutions. The second generation of the report is all patents cited during prosecution of all patents in the prior group. The report can also include an analysis of all patents that subsequently cite patents A and B (after issuance of A and B). The analyzer can be sued with all other forms of IP.

Another feature of the search function 1002 optionally is the image annotation tool 1006. The annotation tool 1006 enables users to annotate images and text in IP, including patent drawings. Those annotations can be saved and can be categorized. For example, annotated drawings or images can be saved in the context of projects in order that notes and other thoughts of the user can be tied to a project. A further aspect of the patent text data base function 1002 is its ability to incorporate online information relevant to the analysis trend. One automatic link anticipated by the present invention is the online case law data feed 1008. Case law data, preferably provided online, is essential to analyzing IP law with respect to various aspects of IP including patent texts and claim constructions, the copyright scope, the goods and services covered by a trademark, the mark's secondary meaning, etc. that are being reviewed by the user. As a result, the user can perform a search on the case law relating to relevant questions that arise in the context of a search.

A further optional feature of the IP analyzer 104 is the project analyzer 1010. The project analyzer enables the user to group IP into specific projects. The value of using projects 1010 is that it enables the user to tie, for example, patent data and other intellectual property data, to a client product, service, competitor issue or any other valuable target for analysis (such as a due diligence in a corporate transaction). The project tool enables a multifaceted ability to exist for analyzing intellectual property assets. For example, the user can tie their patent data 1012 into a variety of competitive categories. They can, in a project context, correlate the client's international patents, trademarks or copyrights with that client's products or services. All patents, trademarks and copyrights protecting a client's product can be linked to a client's product project and the patent can be analyzed or annotated for that project using the annotation capability 1006. For example, some of the patents analyzing product A may also protect a second product, but the analysis of these patents in relation to the second product will be linked to the second product's project from the first project.

A further optional aspect of the project analyzer 1010 is the ability to tie to a project, the client's international patents, trademarks, copyrights, etc, with a competitor's products or services. For example, all patents, trademarks and copyrights supporting the client's first product could be linked to a first product's project that is analyzed in the context of a competitor's product. All infringement analysis of the competitor's product relating to our infringement of our client's product will be linked to a specific project. For example, separate claim charts can be generated in the context of this project for every patent allegedly protecting the competitor's product as those claims relate to each of our own client's patents protecting our client's product. There may or may not be intellectual property protecting the competitor's product. In this case, the user's manuals, drawings, technical manuals, marketing materials and any other useful information relating to that product can be scanned and automatically linked to the project for analysis.

Likewise, a project correlating a competitor's patents, trademarks and copyrights can be made to the client's products and services. As described above, patents, trademarks and copyrights supporting a competitor's product A could be linked to the product A project in the context of our client's product B (which may or may not be protected by intellectual property). The potential infringement analysis or design-around study could then ensue. This analysis could readily relate data on Product A to our client's product B which will be linked to the specific project. Claim charts can then be generated in the context of this project for each patent protecting our client's product B as the claims relate to each of the competitor's patents protecting product A. In this case, if there is insufficient intellectual property coverage of product B, then other information scanned and automatically linked to the project for analysis will be used instead.

A further feature of the project analyzer is the analysis of project contributions 1014. Specifically, every contribution to a project by an individual (in the form of annotations and linkings) is recorded within the analyzer. When the analysis is reviewed and linked to a project, the project leader/managing partner can assign weights to each contribution and generate a resource usage report which indicates the relative contributions of each of the individuals working on the project. For example, associate attorneys A, B and C may each provide pieces of an infringement analysis in relation to every claimed phrase in the claim chart which compares a competitor's patent to a client's patentability. The managing partner can, at the end of the project, review these three annotations. The managing partner can then pick and choose which annotations to use in the final claim chart. The project leader can generate a report indicating the relative contributions of each of the associates. The content evaluation model provided by the resource usage data can easily be applied to more complex projects, particularly where those projects involve scores of people screening hundreds of patents relating to a particular design-around project. The project manager can quickly isolate each individual's contributions, and data provided by that individual.

Another optional aspect of the project analyzer is its ability to perform disconnected operations. Clients will be able to check in and check out 1016 from projects. If management functions or work functions remain unfulfilled, the IP analyzer 104 will automatically resynchronize the project and notify the project manager of the need to fulfill certain remaining management functions. If there are multiple attorneys assigned to analyzing patents, for example, and only six of the nine patents of interest have been assigned and dealt with, the project manager can be notified of the remaining three patents and reassign those patents to others.

Another optional feature in the IP analyzer 104 is the IP family data base 1020. This data base management tool enables the analyzer to integrate a variety of IP family data from various sources. In particular, the tool 1020 works with the analyzer to pull together disparate patent family information. For example, patent family information that derives from the docketing system 110 can be provided to the patent family data tool 1020. That data can be added to traditional patent family searches from the world-wide-web or other recent data resources including Derwent and Inpadoc. As a result, the integrated patent family date can be plugged into a family tree visualizer 1022. Similarly, if multiple copyright registrations belong to one artist or author, they can be tied together in the same fashion.

The optional visualizer 1022 creates a tree of the entire family of related IP. As a result, an end user can easily read the tree of all members of the family. That tree includes for example, foreign publications and patents, reissues, re-examinations, divisionals, continuations (file wrapper continuations, continuations-in-part, CPA applications, PCT applications, etc.), copyrights, trademarks (US and foreign).

Another optional feature of the IP analyzer is the claim chart generator 1030. The chart generator automatically (or by customization) separates claims into key phrases. Those phrases are then automatically linked to portions of a patent specification's text as well as the related patent images. The user can receive an automatically generated claim chart that is linked to key claim phrases, relevant text and images for analysis. The output of that analysis is provided to the claims and text analysis database 182 which, as shown in FIG. 1, is a database resource for the entire system. The generation of automated claim charts 1030 also is linked to the report generator function 1040 so that customized claim charts can be placed into a report format according to the wishes and desires of the user. The multi-report generator is designed to provide publishing a report on the Internet, Intranet and/or Extranet or any other distribution channel identified by a client.

The optional multi-report generator 1040 includes enhanced visualization tools such as Excel charts and spreadsheets that are used to automatically generate an analysis. Clients will also have publishing tools that allow restricted access to certain fields, reports, records, etc. for their projects. For example, an IP analyzer client (such as a large intellectual property law firm) can provide web access through a secure server to its individual clients for different projects. In addition to generating reports, all the search and watch results are available for downloading from a remote web site (or internal storage site) through a secure server. The report generator is able to download to an Internet storage data base 175 (see FIG. 1), which through a secure server is accessed through the World Wide Web.

The customization feature of the report generator may utilize default templates and/or custom templates and custom applications 1042 set up by the client. Those applications provide an automatic integration capability with other applications for the IP integrated system so that docketing, licensing, prosecution, foreign filing or annuity information automatically links into the report. Moreover, the multi-report generator provides all the results in electronic form for automatic integration. Results are sent, for example, via e-mail or through a CD, depending on client preferences. Moreover, the report generator can correlate patent, trademark, and/or copyright analyses relative to a product or products belonging to the client or to a client's competitor. Other linkages can include administrative, manufacturing, advertising and sales-related data belonging to a client tied to a particular product or service being analyzed.

Additionally, clients can construct strategic (“what if”) scenarios in the analysis application 1070 integrating data from all projects in the various applications of the IP office suite in order to make business decisions. For example, clients can determine the probable outcome if their company decides to invest money in the development of a first project and secure worldwide patent coverage for that project in countries A, B and C. In addition, the client (and their counsel) can construct “what if” scenarios relating to competitors. The IP analyzer can generate reports and visualizations relating to questions such as “what worldwide intellectual property coverage has competitor number one secured in relation to product number one,” or “what worldwide intellectual property coverage patterns emerged during the last five years in relation to competitor one.” Further questions include but are not limited to “during the last ten years what patterns emerged in relation to when competitor number one allowed U.S. and foreign patents to lapse and are these patterns related to any specific products.”

It is anticipated that all aspects of the IP analyzer will be certified to be integratable with other prominently used tools those tools include, for example, Microsoft Outlook, Microsoft Word, Microsoft PowerPoint, PC-DOCS by Hummingbird, and many other known or used products. Other features include an interactive wizard-based help menu and scalable data storage allowing all intellectual property personnel to have access to the information and support for clients to integrate custom data (as well as image files into the system and into the context of a given project.

A further feature of the analyzer includes the negotiation and presentation application 1050. In this application, clients generate presentations based on projects relating to a particular negotiation. This application works in conjunction with the IP analyzer as well as the IP licensing tool so that data from the licensor can be provided as input to the negotiation application and vice versa.

The optional negotiation/presentation application 1050 provides a professionally organized multimedia presentation of the specific details relating to the negotiation. For example, a client can roll through an entire arsenal of IP relating to a particular product or service that invalidate the claims of a competitor's patent in relation to that competitor's product. This presentation is invaluable when a user needs structure a rationale in support of royalty for a license for the hypothetically invalidated patent. The presentation of the client's patent also includes detailed phrase by phrase patent analysis, annotated patent drawings and claim charts produced from the claim chart generator 1030. Optionally, some or all of the data provided to the IP analyzer may be automatically encrypted, such as by a data encryptor 1060.

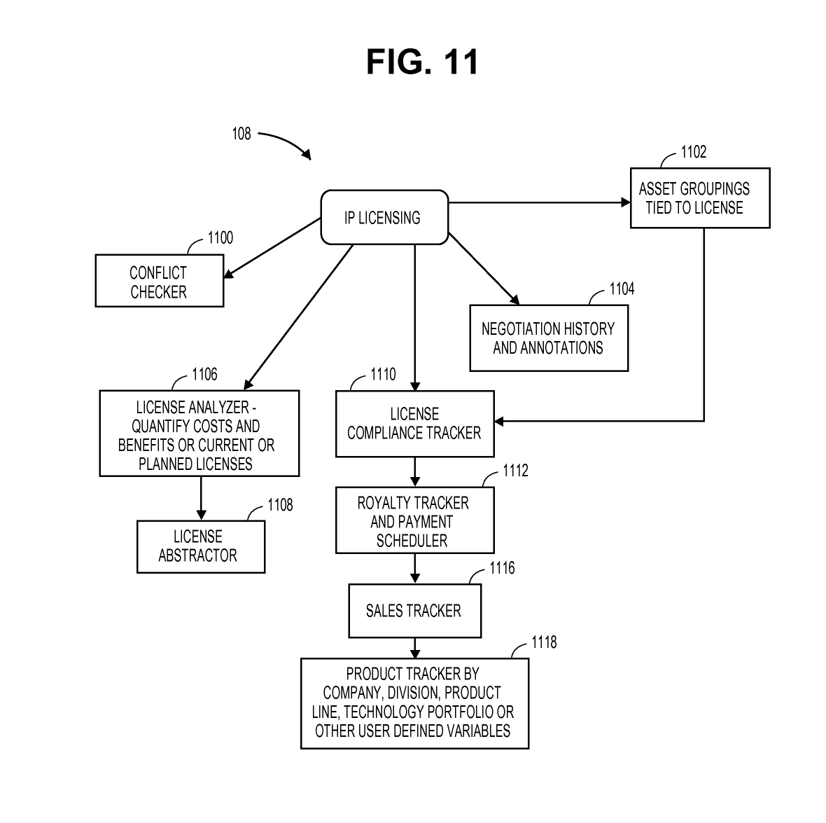

Referring now to FIG. 11, one embodiment of the IP licensing application 108 is shown in some detail. As previously mentioned, the IP licensing application develops and derives information from it database which provides a resource to the other applications in the suite. Data from the IP licensing application may be available to and integrate with the other IP applications. Importing of data from a commercial third party source is optional, but not necessary. However, it is anticipated that commercial databases may be integrated. There also are clients with custom in-house licensing databases that request the creation of an import tool to transfer client data to the IP licensing application. Moreover, as shown in FIG. 1, the results of the IP licensing application 108 may be made available on the web, Intranet, Extranet or through the communications bus 102. One of the optional features of the licensing application is to tie IP assets to standard licensing packages. Thus, application 1102 enables the client to tie a given IP right to one or many licenses, affiliated trademark registrations with licenses being developed, or copyrights. Information developed from the grouping exercise is provided to a database that serves as a resource for the overall system including, but not limited to, the IP analyzer application 104.

Another optional application that may also provide valuable license specific data is the negotiation history application 1104. The purpose of the negotiation application is to associate with each agreement, or agreement package, deal annotations taken in real-time or in summary form. This negotiation history may be segregated on a per client basis for later use and analysis. The information can be provided to the licensing database 109 for easy reference by the licensor and other applications of the system.

Another optional analytical application is the cost analyzer 1106. The purpose of the cost analyzer 1106 is to assign costs and other payment schedules affiliated with licensing packages. This analyzer is valuable, for example, for a client with a large and diverse product base. It enables that licensor (or licensee) to track royalty and other costs associated with the license. Tracking can occur for a host of reasons. For example, licenses are tracked for uniformity and consistency as well as for the success of negotiation strategies. The cost analyzer application 1106 may be critical to certain users, e.g., having the maintenance of a large licensing scheme where losing track of the royalty rates can provide disastrous circumstances. For example, a licensor may have signed licensees up to a “most-favored-nation” royalty guarantee. By failing to monitor the royalty amount, a licensor can be held in breach if they were to lower the license royalty rate below the most favored nation rate and not offer that rate to the first customer. The license analyzer also provides a royalty tracker capability 1112. The tracker automatically tracks royalty payments by licensees. Payment schedules for licensing packages can be monitored. The license analyzer 108 optionally includes a license abstractor 1108. The abstractor provides scenarios for varying costs and quantities of licensing packages. Thus, the licensing negotiator can “cost out” a proposed license agreement and measure its benefits and costs accordingly. The ability to track license royalty payments comes as a result of the data feed from the license compliance tracker 1110. The compliance tracker may include an application 1112 for tracking royalty payments according to a preloaded schedule. The tracker includes a calendaring function which has due dates for royalty payments that are in accordance with the negotiated license. Payment information received from the accounting application 1114 may update an electronic calendar indicating that a royalty payment has been received on time. It may notify the license manager that a payment is late. Moreover, the royalty tracker automatically generates an interest payment or penalty fee in accordance with the terms and conditions of the license agreement. Also, the tracker notifies the license manager of upcoming due dates and, also provides that due date as an e-mail to the licensee as a reminder that a payment is coming due. Another optional feature of the license compliance tracker is the sales tracker 1116. This application tracks product sales data based upon user-defined variables. The variables include geographic and territorial limits that are linked to public records showing sales data. Moreover, the product license tracking capability is definable by: company, company division, product line, technology portfolio, patent number, trademark, copyright, license, any user defined variables or license.

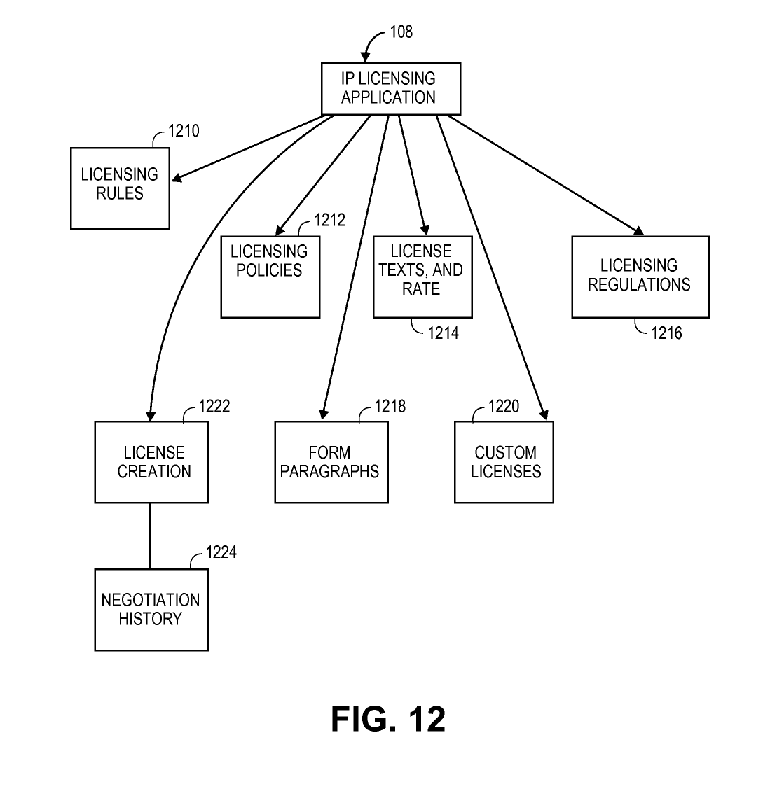

FIG. 12 illustrates other optional aspects of the licensing application 108; all of the illustrated applications are optional, and various embodiments of the invention may include some of these features and/or other features as well. The purpose of the applications shown in FIG. 12 is to relate data relative to licensing in a manner that is highly scalable. That data includes the database of international licensing rules 1210. The rules 1210 may include, for example, the European Economic Community, and other international licensing treaties that impact the terms and conditions of any agreement. Data base 1212 may be employed to reflect a company's licensing policies. A negotiator may not know that a company is only willing to go so far on a particular clause (such as indemnification limits, confidentiality restrictions, coverage liability, royalty rates, etc.). That information can be placed on the data base 1212 for use in the licensing application. Application 1214 has information on standard licensing texts (as examples as well as royalty rates). That information is employed in drafting a license agreement using industry-wide practices or known formats. Finally, the rules and regulations pertaining to contracting are accessed through database 1216. Database 1216 includes (but is not limited to) the Uniform Commercial Code, the UCMA and other state and local contracting regulations. These databases are used to create form paragraphs 1218 or customized licenses 1220. These data are also used in the license creation application 1222, which through an interactive process with the end user, develops a license agreement that is designed either from the form paragraphs or customized paragraphs.

It is anticipated that the licensing application 108 may, in connection with some embodiments, have World Wide Web access or the ability to be available to an Intranet or Extranet platform. The IP analyzer 100 also includes the ability to allow negotiators to annotate clauses of licenses in order to assist clients who, when visiting the licensing application via the web, may be used to separately mark up the license agreement. In addition, visualization tools are available for the end user. Clients view statistics and data associated with certain license agreements or even certain clauses in those agreements. For example, a client clicks their mouse on a particular clause and displays its relative usage company-wide or product-wide. The user may hyperlink directly to that clause in a related license agreement to see how it has been used. Finally, the IP licensing application 108 maintains a negotiation history 1224 associated with each agreement or package that is imported by multimedia files (i.e., video animation, sound, etc.).

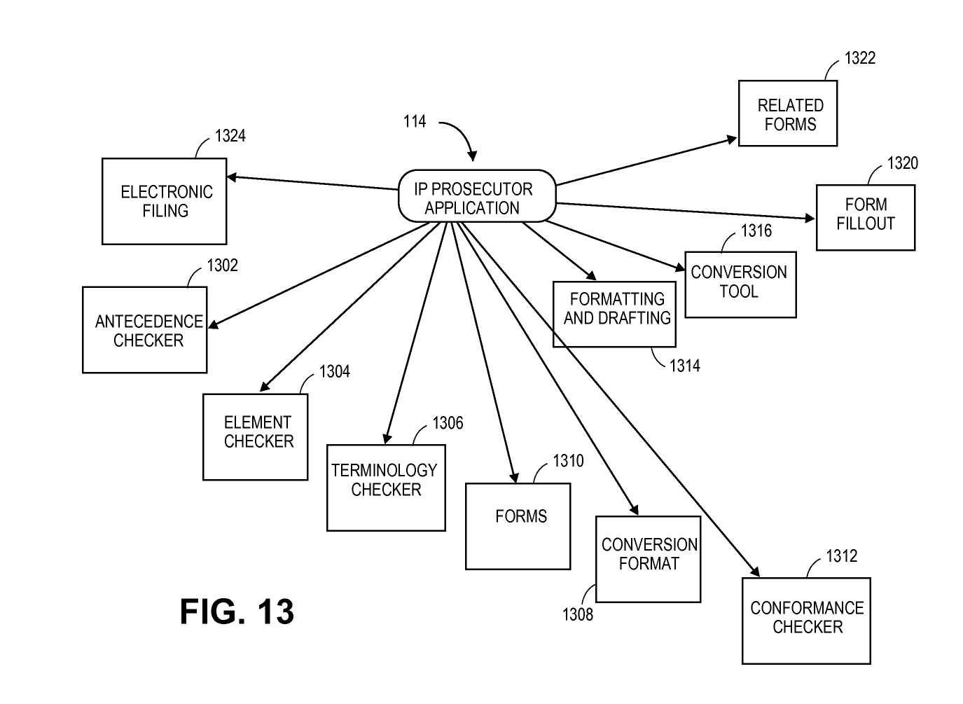

FIG. 13 illustrates one embodiment of the optional IP prosecutor application 114. As illustrated in FIG. 1, the IP prosecutor advantageously works closely with the IP docketing database 214 so that information is retrieved and provided to the database 214 for updating the docketing system and vice versa. Another database that works with the IP prosecution application is the IP annuity data base 113. Again, there is a symbiosis between the Prosecutor and the Annuity databases so that annuity information is updated through the prosecution application and vise versa. Finally, the IP prosecution application advantageously works closely with the IP filer 106 (U.S. and foreign data base) so that the status of a foreign or U.S. filing is updated by virtue of its completion at the prosecution level.

The IP prosecutor application is not only a forms database. While forms products are available in the marketplace, the benefit of an IP prosecution tool is that it provides automated checks and other tools that together add intelligence, power and scalability to prosecution functions. For example, the IP prosecutor application has an antecedence checker 1302. The antecedency checker enables the practitioner, drafting claims, to check for 35 U.S.C. §112, paragraph 2 compliance (to show appropriate antecedence for a particular claim element). Antecedence not only exists within a claim, but also between claims. Dependant claims are checked automatically to insure that they have a proper antecedent basis with the parent claim. It is anticipated that the antecedency checker can be used for other forms of IP work, for example the consistency of term use in a license, or in a copyright application.

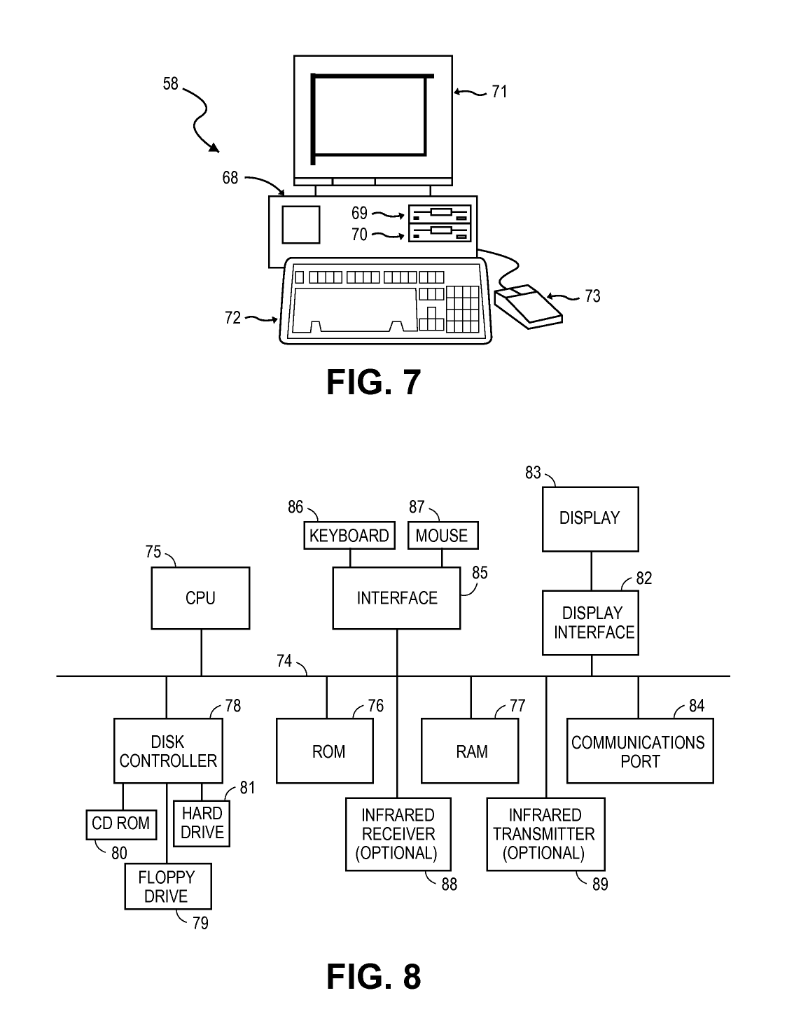

Another feature of the prosecution application is an element checker 1304. A purpose of the element checker, for example, is to ensure that there is consistency in the numbering of elements in a patent application. This checker can be modified to work with any form of IP. For example, if element “102” is discussed both in FIG. 1 and FIG. 7, and each of those numbers refer to a different structural element, then that inconsistency will be announced by the element checker. Furthermore, because most patent applications indicate that “like elements are referred by like reference numerals,” there is a check to determine if two different numbers are affiliated with the same element in the patent specification. A terminology checker 1306 is also employed as a function. The purpose of this checker is to provide the practitioner with an indication that inconsistent or incomplete terminology is referred to in the patent specification or in the claims affiliated with that specification. Additionally, the terminology checker 1606 includes a thesaurus that allows the user to check alternative terminology for the elements being described. In performing the prosecution tasks, the majority of prosecutions forms may be provided from a forms database 1310.

Once the forms are produced, a variety of tools can also be used to manipulate those forms in a way that is user friendly. For example, the conversion PCT/EP format application 1308 enables those forms to be manipulated to fulfill the filing formalities required by the Patent Cooperation Treaty or the European Patent Office. In addition, a conformance checker 1312 reviews a completed application, including the diagrams with that application, to determine whether or not it meets a practitioner's standards. A figure is also reviewed by the conformance checker to ensure that it is properly labeled, contains appropriate margins, and has correct numbering in accordance with U.S. and non-U.S. drafting standards.

A formatting and drafting database 1314 is available for the end-user to access during prosecution. A conversion tool 1316 is employed for converting forms into an XML format for use on the Internet. Once these tools are used to produce the application, then automatic prosecution functions can be used. The first function, the form fill-out 1320, takes a variety of data from the docketing database 111, including the client address, Patent Office Art Unit or other IP granting agency locale, including Serial Number, Control Number, Filing Date, Registration Date, the Examiner name, paper number, and other information pertaining to the prosecution record, and places that information into the correct portions of the form. The practitioner can then develop whatever substantive comments need to be placed into the form. He/she can then use the various tools previously mentioned to correct and improve the document. In addition, related forms are generated at 1322 driven by the docketing systems information that, by using program logic, automatically defines the forms that are necessary to complete the prosecution. For example, if a new patent application is to be filed, then a patent application form will be generated at 1322.

Once the application is written, the system 1312 checks for antecedents in the claims and the elements in the terminology. The document is converted to the appropriate format e.g., an XML file (if electronic filing is anticipated) at 1316. The converted forms to the filing are then generated. Those forms include, for example, a check request for the filing, a post card for accompanying the transmittal, a transmittal form for the new application, a checklist that requires the practitioner to indicate that all appropriate elements in the application have been included and even a messenger slip, fax cover sheet or electronic transmittal cover page, for delivery of the application to the relevant agency such as the U.S. Patent and Trademark Office, (or for that matter any other relevant foreign office). Once those forms are filled out then the system includes an electronic filing transmission function 1324. The transmission and filing function meets all the requirements of the electronic filing standards set by the U.S. Patent Office as well as other U.S. and foreign governmental agencies. Upon filing, the docketing entry is updated and that information is transmitted to the docketing application 110 for updating.

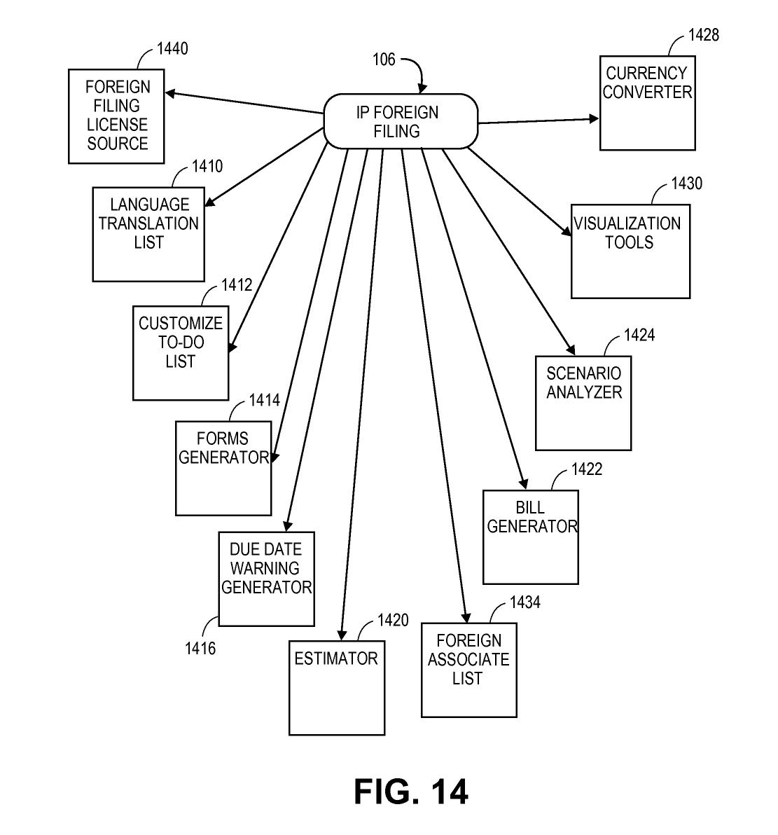

FIG. 14 illustrates the IP foreign filing application 106. Aspects of the foreign filing application are disclosed in U.S. Patent application Ser. No. 60/277,282, hereby incorporated by reference.

The IP foreign filing application 106 provides tremendous power enabling the IP prosecutor to transfer data between their clients and foreign patent and trademark offices, foreign associates and other attorneys working within the IP group. The data used by the IP foreign filer is primarily patent, trademark and copyright related. Often these properties need to be foreign-filed prior to a deadline (often a bar-date deadline). As shown in FIG. 1, the foreign filer is accessible directly from the Internet, Intranet, or Extranet. The extranet connection may be used by, e.g., foreign associates who wish to obtain prosecution data for filing overseas. The foreign filer may rely on a number of tools to maximize its efficiency. First, an automated software base translation application 1410 is used. That application provides a foreign language document translation (to/from English). Typically the foreign language list is limited to languages of the major IP filing countries (Japanese, German, French, Spanish, Chinese, Hebrew). Any number of known language translation programs can be used. An optional tool is the customized to-do list 1412. List 1412 relates to foreign filing requirements based on documents already filed and documents waiting to be legalized or filed. The list derives a majority of its information from and provides information to docketing database 214. Another feature of the foreign filer 106 is the forms generator 1414. The foreign filer, much like the prosecutor application, has the ability to automatically generate all forms, including detailed instructions for users. The users can thus interact with the instruction menu and fill out the forms in accordance with local and national practices. In addition, the forms generator 1414 may generate, for example, current mailing addresses, hyperlinks, and/or also may facilitate communication via facsimile and/or e-mail through the integrated system Website with correspondents, e.g., foreign personnel regarding, among other topics, the legalization of various documents.

Another aspect of the prosecution follow-up functionality, according to one or more embodiments of the invention, may be a due date warning generator 1416. This due date generator comprises a list (provided to the client, and anyone designated by the client) for automatic reminders (inventors, client customers, foreign agents/associates, co-counsel, other attorneys assigned within the office to handle the matter). The warning application may be triggered by the docketing databases, the system clock, calendar and/or various rules.

An important consideration in foreign patent prosecution is cost. Foreign patent prosecution is often expensive, particularly when the cost of a case is multiplied across multiple countries. Figuring out the cost can be tricky, since foreign currencies, currency fluctuations and taxes are often involved. The IP filer takes care of this problem by estimating the filing and prosecution costs 1420. The estimator 1420 may be linked, e.g., hyperlinked, to the relevant U.S. and foreign patent office sites that contain information pertaining to prosecution fees. The estimator may rely on an MS Excel spreadsheet format readily to visualize the fees. In accordance with one or more embodiments of the invention, the estimator may be also connected to a bill generator 1422 that may generate bills, preferably in real-time, for filing foreign patent, trademark and other types of applications.

In accordance with one or more preferred optional embodiments of the invention, all transactions relating to the foreign filer 106 occur through a secure server. That secure server may employ one or more security techniques that are designed to ensure confidentiality and/or quality. For example, the optionally transactions may employ cryptography and/or cryptoanalysis, which may be on a country-by-country basis. Also, authentication technologies, such as SSL, optionally may be used, tending to ensure that the right parties are receiving the right information. Optionally, as a further assurance of quality and accuracy, the entry of some or all data does not derive from manual input, but electronically, e.g., from the docket. Thus, incorrect data entry is dramatically reduced or avoided.

In addition to communicating foreign filing information with co-counsel, the IP foreign filer 106 communicates post-filing information between clients and associates. Post filing information is combined with the scenario analyzer 1424 to help those clients visualize hypothetical scenarios and analyze the best strategic approach. Those scenarios assess a single patent or the entire IP portfolio to develop appropriate strategies. For example, suppose a corporation institutes a policy of filing applications only through the European Patent Office (EPO) rather than the PCT; the analyzer could project, through the cost estimator 1420, the expected cost differences and timing differences in order to get a reasonable projection of this strategic shift. The scenarios are presented using a various visualization tools 1430, including, e.g., spreadsheets.

In order to effectuate foreign filing, the user first accesses the foreign associate list 1434 which contains the names and addresses of various foreign patent attorneys—listed by country. Each client can also create a preference list for identifying preferred attorneys/agents. The user then chooses a specific foreign associate for each country. The user can also specify attributes for the filing which can affect fees, and, of course, the way the case is treated. User attributes include the number and type of claims, the length and/or number of drawings, small or large entity etc. An additional feature is the currency converter 1428 which is used in generating filing estimates, bills, and any other cost related deliverables.

Another optional database used by the foreign filer 106 is the foreign filing license source 1440. This resource can be tied to docketing in order to direct and control the timeliness of foreign filings in accordance with the deadlines imposed by U.S. Export Administration, U.S. Department of Commerce.

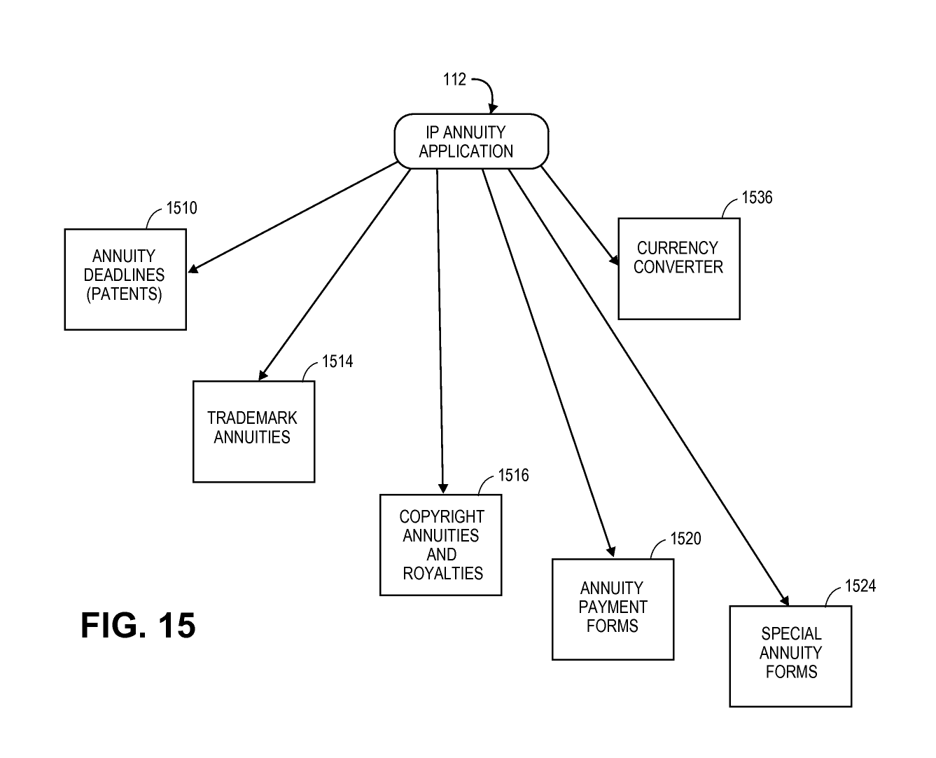

FIG. 15 is an overview block diagram of on embodiment of the IP Annuity application 112. The annuity application 112 preferably relies on data developed by other applications. In particular, the annuity application advantageously obtains information from the docket (or a third party docket) to generate a timely-paid annuity. Once that data is received, clients will receive a list of impending annuity deadlines 1510 differentiated by patents, trademarks 1514 and, to the extent it is applicable, copyright/copyright royalties 1516.

One way to access the annuity application is via the IP docketing application. By going through docketing, clients receive a list of impending due dates tied to docket numbers. To further speed up annuities processing, the annuity application 112 optionally produces client-specific annuity payment forms 1520 so that the system saves the firm's docketing department from creating a separate set of letters and reminders. Alternatively, or in addition to 1520, product-specific annuity forms 1524 can be generated, if for example different departments for a single client are responsible for patents for different products. As a third alternative, an annuity form that is specific to a type of IP can be generated.

Once it is determined which annuities are to be paid, then an automated payor application 1520 is activated, e.g., by the IP engine. The payor then uses a currency converter 1536, withdraws money from the firm or client payment account, and transmits payment, such as by a secure payment connection, to the foreign patent office or agent. The client docket records may be then automatically updated, and the docket information is returned to the docket database.

As a result of the efficiency of the fully automated approach to annuity payment, little lead time is required in advance of the annuity date, thereby allowing clients to make better decisions on the retention of patents/trademarks.

The features and functions of one or more embodiments of the IP organizer application 118 are set forth in U.S. Provisional Patent Application Ser. No. 60/277,282, expressly incorporated herein by reference.

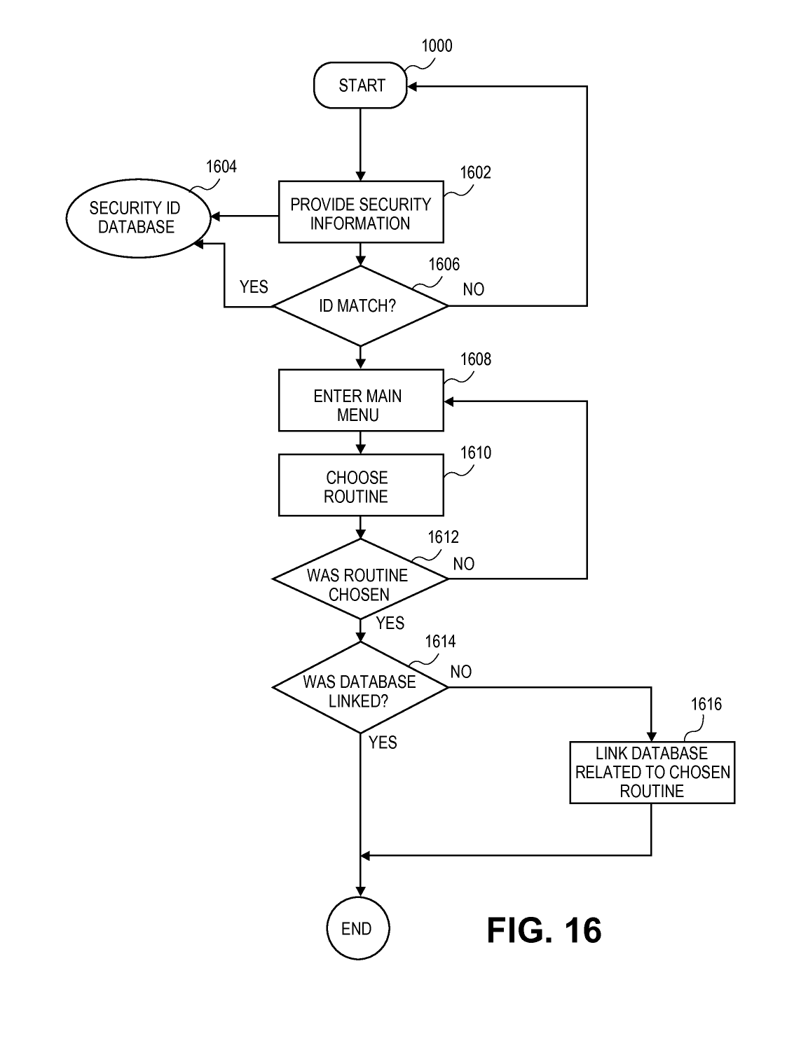

FIG. 16 is one example of a flowchart showing initiation of operation of the IP Engine used in connection with the present invention. The “start” point 1000 in the flowchart represents, for example, a “start screen” for an accessible website. Alternatively, it can be an entry screen for a stand-alone application. Regardless of the platform, the user preferably provides appropriate security information, such as a password, personal identification number (“PIN”) or security Key (“security-ID”) at 1602. The security ID is then referred to a look-up table containing the security 1604 stored in a security-ID database. The security-ID codes are matched at block 1606. If there is no match, then the user can retry at block 1000. Otherwise, the user is able to access the main menu 1608, or the user-entry home page.

The home page preferably is a visual representation of the various applications comprising the IP system, such as shown in FIG. 1. The user is provided with a series of options (e.g. icons) enabling quick access to the numerous tools/functions comprising the IP system. The user then selects a routine 1610, which after being selected at block 1612, the data sources are automatically linked at blocks 1614 and 1616, whereupon the applications from the suite of IP functions are selected. Note that the database may be linked via a commonality, as discussed herein.

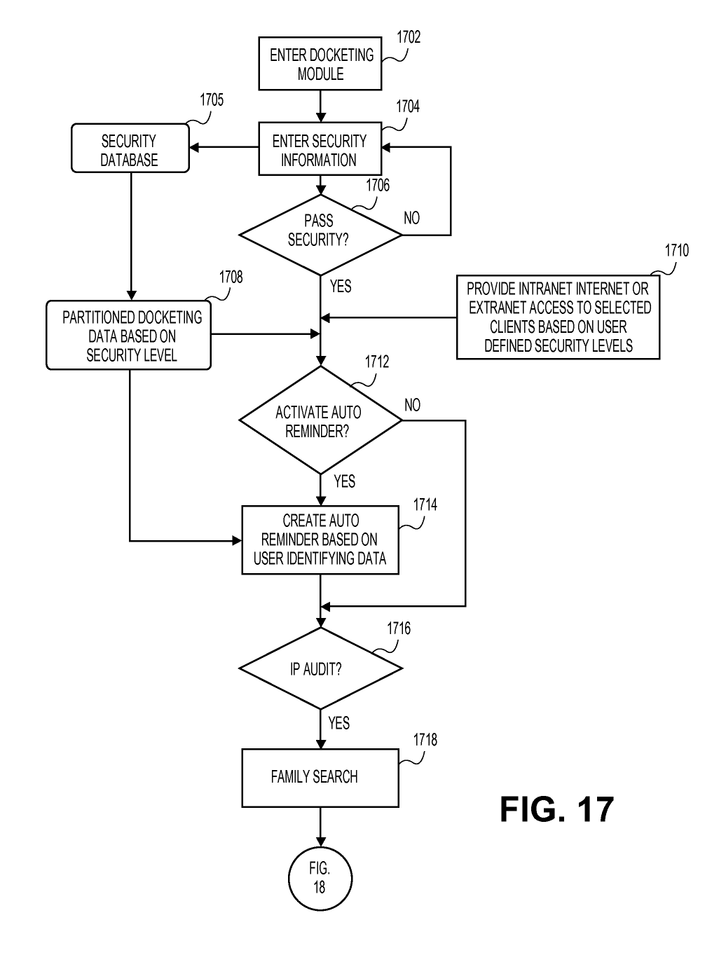

FIG. 17 is a detailed flow chart showing the operations of the IP docketing application 110. Upon entry 1702, the docketing application 110 re-queries the user for their password, PIN or other security identifier. The purpose of this extra layer of security (above and beyond the entry screen) is to differentiate the level of access to soliciting information for the user. Again, the security database 1705 is accessed, and assuming the user passes scrutiny 1706, the user gains access to the docketing application.

As previously noted, docketing data (and some functionality) is preferably partitioned. Access to levels and types of data is dependent on the user's level of security. For example, a customer, having access through an Extranet may have a read-only low-level security clearance. That customer may only be able to have read-only access to those docket listings just for them. At the highest level of security clearance, a chief docket clerk will have the ability to add or modify any given docket entry, regardless of who the client is.

One of the optional IP wizard features is whether the user wishes to activate the auto-reminder 1712. Once turned on, the auto-reminder will send out docketing deadline information for that user, in the form of email messages. A user having a high security clearance can also turn on (or off) the auto reminder for other users. Thus, the docket professional can activate the auto-reminder function for all system users or a subset of those users.

The auto-reminder can also be specified at 1714 based on user identifying data. The user identifier is connected to a partitioned security table 1708 to insure that the auto reminder functions do not disclose data beyond an individual user's security level.

Once the auto reminder has been set, then the user is asked whether he/she wants to participate in an IP audit 1716. If the user agrees, then a family search is implemented at block 1718.

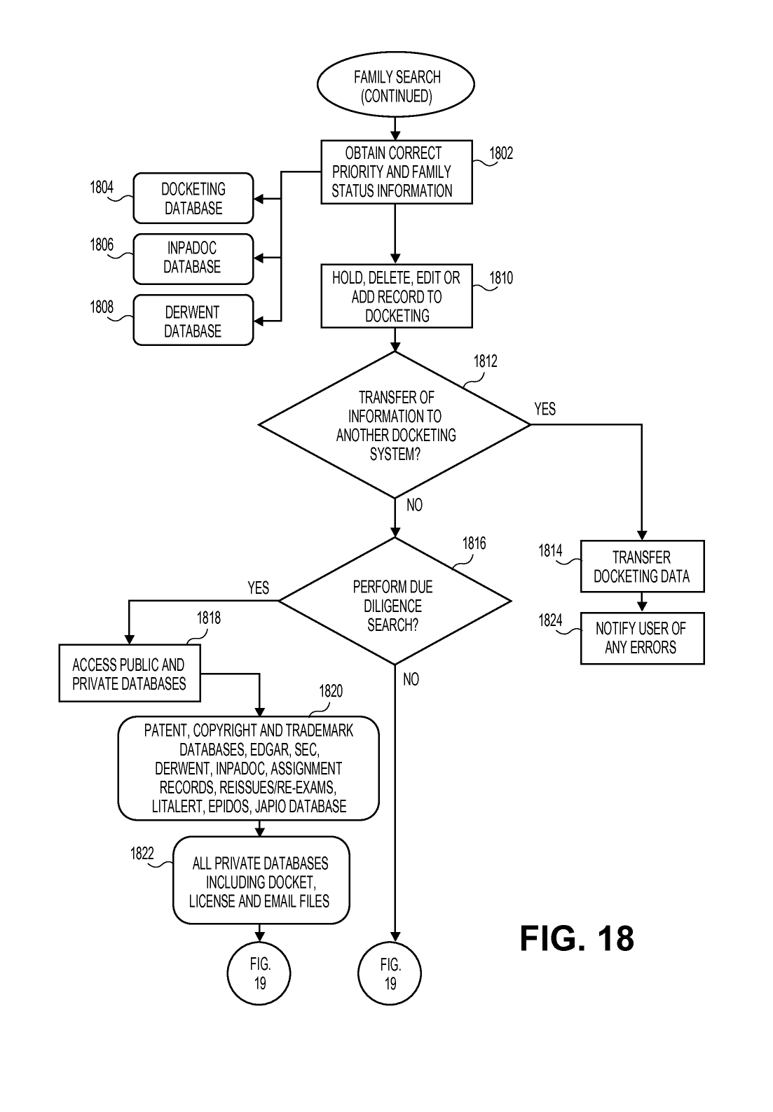

In FIG. 18, the user is asked to obtain the correct priority and family status information. The user then has the option of going to several databases 1804, 1806 and 1808. For example, the docketing database 1804 gives the user the correct priority data. Family status information can then be obtained from the Inpadoc and Derwent databases 1806-1808.

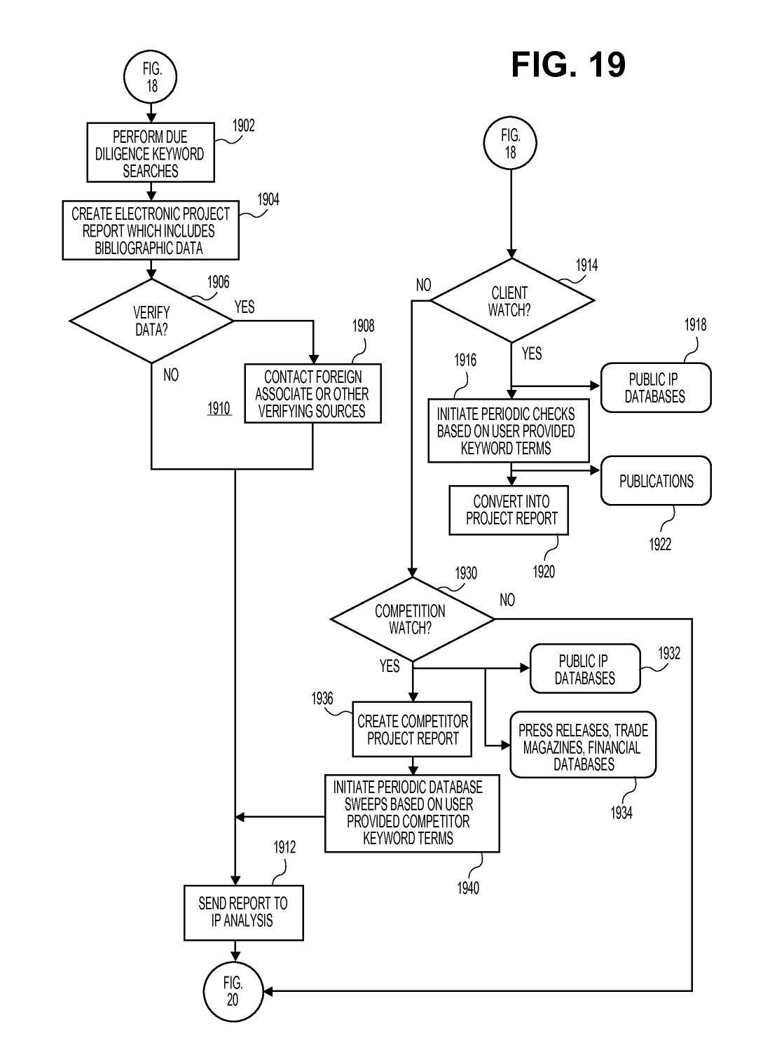

Once the family information has been updated, the user (presuming that he/she has a sufficient security level) is able to modify the docket entry to reflect the family search results. If the user is working on other systems, having other docket software, then at 1812 the family search results are transferred to that system. Another audit option is the due diligence search. If the user wants that type of search, then at block 1818, they access public and private databases. The databases are then reviewed, and are called based upon the type of information desired. For example, if the user has interest in conducting a worldwide patent due diligence investigation, then the Derwent database 1808, along with the USPTO and private docket databases are automatically accessed at blocks 1820 and 1822 (through the keyword search 1902. (FIG. 19)). Upon completion of the search, an electric project report is created at block 1904, which includes a bibliography of the search resources.

At Block 1906, the user verifies the search results. If there is a need for a more detailed verification at block 1910, the foreign associate or other source of verification is contacted. These other sources for example, include Dun Bradstreet, the US Patent Office Patent Assignee Assignor index, or any other known reference sources related to the various forms of IP. Once the information is verified, or if no verification is necessary, then the system reports the information to the IP Analyzer at block 1912.

If the client did not choose the due diligence search at block 1816, then he/she can select the client watch function 1914. The purpose of client watch is to allow the client/user to initiate periodic checks of their portfolio based upon user-provided keyword terms 1916. This check can be accomplished by accessing public IP databases 1918 and publication sources to obtain the appropriate IP data. Once the check is complete, then the project can be converted into a project report 1920.

The user can also access a competitor watch function 1930. Competitor watch operates similarly to client watch 1914, except that all of the data sources are public, i.e. the public IP databases 1932 and the public press releases, magazines news and other databases 1934. Once the check is complete, then a project report issues at block 1936. The competitor report is either produced once, or from periodic sweeps that can be initiated block 1940. A sweep may be set up to reflect any period of time set by the client. It constitutes a similar review of similar material as the one-time competitor watch report.

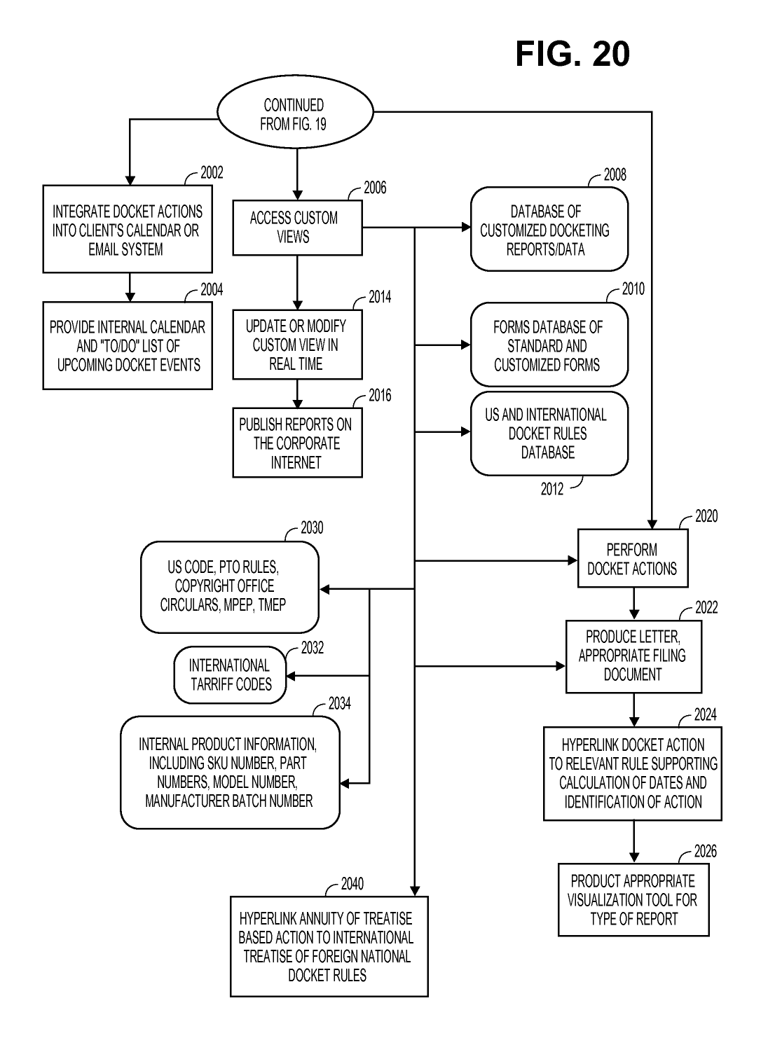

FIG. 20 provides further functional details regarding the docketing application 110. As shown, another action that can be taken by the user is to integrate docket actions into the client's calendar or email functions. For example, the present invention integrates with Microsoft Outlook (website/portal and desktop software). When an action by the client or clients counsel is due, the docketing system emails and places a reminder on the client's or client's customer's calendar. If the IP prosecutor application 114 is employed along with the docketing application application, then the prosecution forms (already filled out with the client case information) may be provided.

Another optional feature of the calendar/email function is the capability of the system to access custom views 2006. This feature allows the client to create custom docket reports. In tandem with the custom view 2006, is a custom database of docketing reports and data 2008. The custom view application also relies on a forms database containing standardized and custom forms 2010 as well as a database of the US and international prosecution rules 2012.

A further optional feature of the custom view 2006 is the ability to update or modify the custom view in real time 2014. Also, the custom views can be published on the corporate internet 2016.

Another optional function of docketing application 110 is the ability to perform automated docketing functions, produce letters and appropriate filing documents, and hyperlink those actions, and letters with rules that support the calculation of dates and types of actions 2024. The system can also produce a clear visualization of the action required at 2026. A report is then produced, as needed.

Elements 2030, 2032 and 2034 represent data sources supporting various optional aspects of docketing. Data sources 2030 represents the primary data source for searches of US-based docketing/office action responses. Data source 2032 comprises the international tariff codes for shipped products/services database 2034 feature product information such as stock numbers, part numbers, models and batches. Finally, function 2040 creates or responds to a hyperlink of treatise-based actions to international treatises of docket rules.

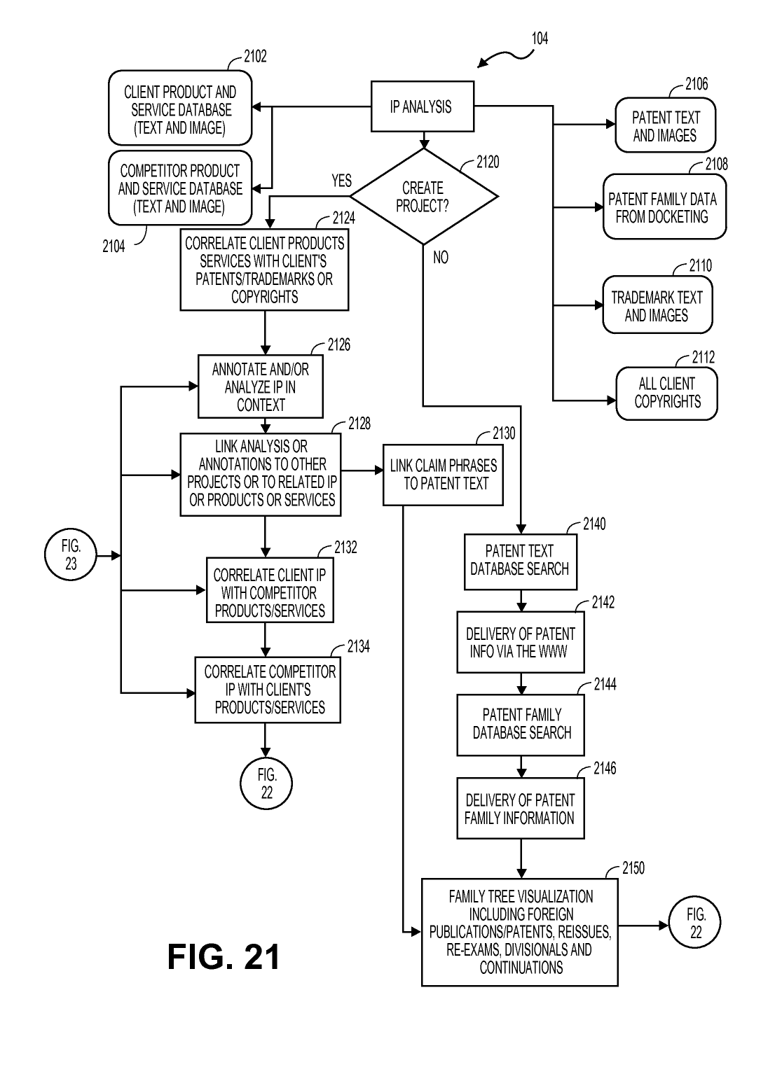

FIG. 21 is a functional-level flow chart of the operations of the IP Analyzer 104. The analyzer 104 advantageously relies on a number of data sources including a commonality descriptor (e.g., client product and service description) database 2102 and a competitor product and service database 2104, preferably with the same features. A variety of intellectual property databases are also useful, including patent text and images 2106, patent family information 2108 (built from the family search function), trademark texts and images 2110 and copyrights 2112.

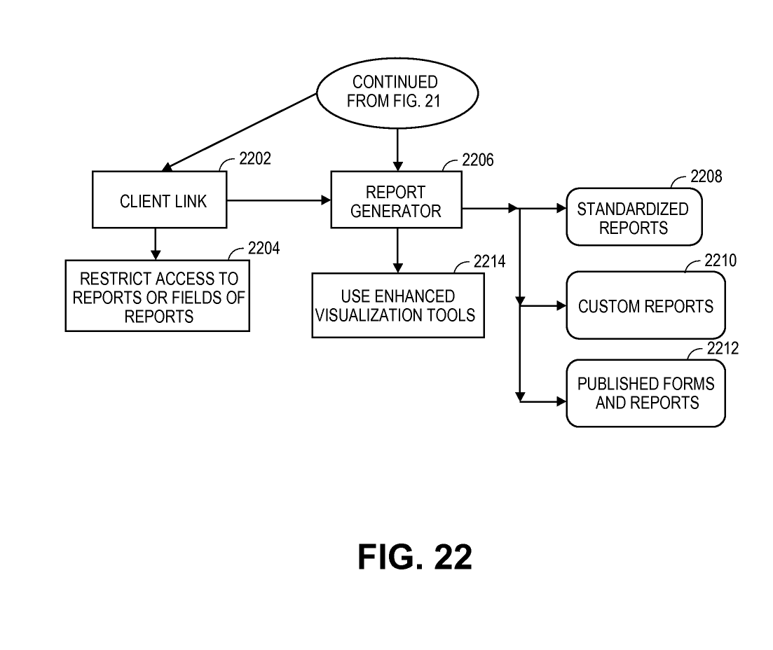

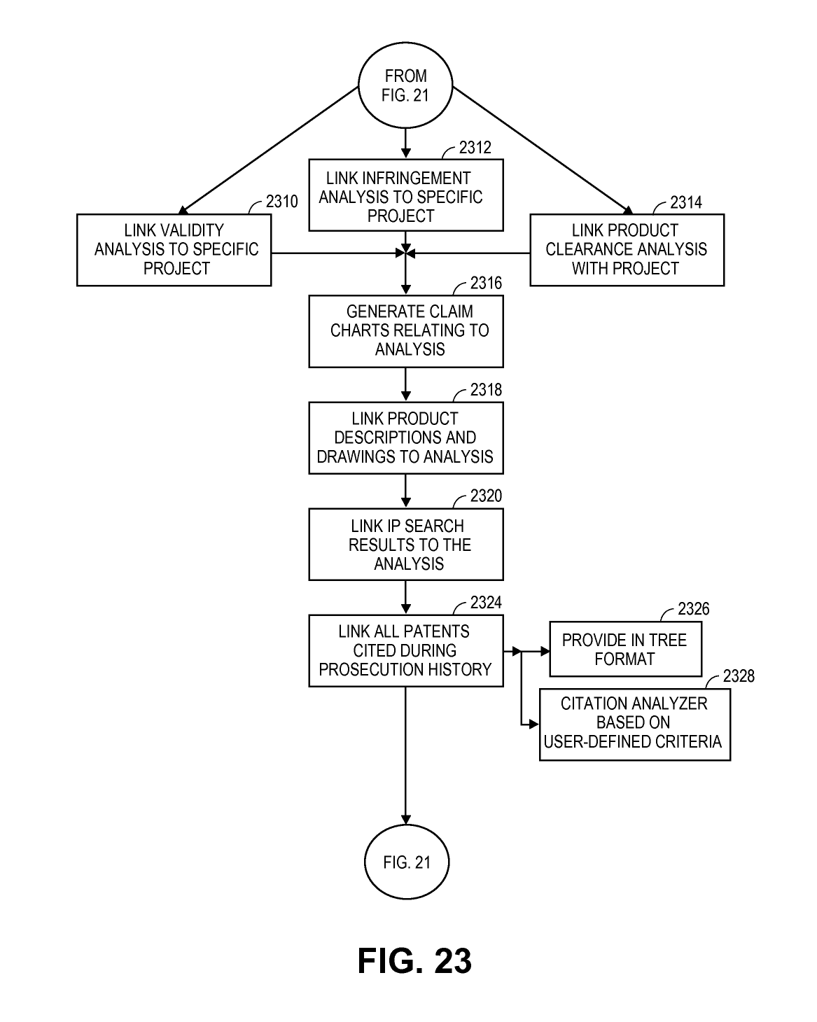

The user may request whether or not to create a project. If the client selects this function 2120, then the system automatically correlates the client's products/services with their patents/trademarks or other IP rights 2124. Once these rights are tied to products/services then the client can begin to annotate and/or analyze their IP in context 2126. To assist the analysis, an annotation capability may be provided. The analysis can be linked 2128 as the client sees fit. For example, the client can link to other projects, other products, other services, other IP rights. Also, the client can link actual claim language to patent text 2130. Once the analysis has been completed with regard to the clients product or service, or in the alternative, the IP can be correlated with a competitor's products or services 2132 or vice versa 2134. These basic analyses can then be linked to a host of different analyses, outlined in FIGS. 22 and 23, discussed below.

If the user does not specify a project, then they have a number of IP search and delivery options available. Those options include but are not limited to a patent text database search 2140 and the delivery of patent information via the World Wide Web 2142 or the Internet. Users can also perform a patent family database search 2144, and the delivery of the family information 2146. From the family search, family tree data can be visualized including foreign publications/patents, re-issues re-examinations, divisionals and all forms of continuations 2150.

FIG. 22 is a continuation of the IP Analyzer 104 of FIG. 21. As shown, the analyzer outputs include setting up and communicating via a direct link to a client. The link can include any known security for wide-area networks, including SSL, cryptography, firewall protected, Extranets or direct connections to the client-side server. Additional software-based security can be used to partition access, so that certain parties will only see certain portions of the IP analyzer reports.

The reports themselves may be produced by a report generator 2206 which can field any type of data using either standardized reports, from a form-report database 2208 or client-customized reports from a custom report source 2210. The report generator 2206 can also be used to search published sources 2212 for reports, including form books, caselaw constructions of IP analyses, or articles of interest. The report generator also uses a visualization tool 2214 to enhance reports. This tool can utilize well known programs including Microsoft's PowerPoint, Excel or Smart Draw or other graphical presentation items.

FIG. 23 is a block diagram continuation of FIG. 21 (IP Analyzer 104). As previously discussed, the analyzer 104 correlates a client's IP with that client's or competitor's products/services, or a competitor's IP with it's own, or the client's products/services FIG. 21, elements (2124-2134). FIG. 23 illustrates how various types of analyses are linked to such projects, so that the variations can be substantial. Three basic forms of analysis are shown (although it is anticipated that any type of IP analysis can be included): validity analysis 2310, infringement analysis 2312 and clearance analysis 2314. Each of these analyses take data generated from blocks 2124-2134.

The three types of analyses then use the claim chart generation feature 2316 to create claim charts that are specific to the chose type of analysis 2310-2314. Once the charts are generated, then the client can link other information sources to their analysis. The “linking” aspect includes cutting and pasting, hyperlinking or creating footnotes, appendix diagrams or slides. The linked information includes product/services information. This information can include 2318 product/service descriptions, specifications, blueprints, flowcharts, schematics, etc. as well as marketing material, documentation, users manuals, to name a few examples.

In addition to product information, the IP search results 2320 are linked to the analysis. For example, if the project involves a validity analysis 2314, the patents (or other IP forms), summaries and assessed claims can all be linked together in the report. Moreover, if some of the uncovered patents from the search 2320 were not cited by the examiner due to the target patent's prosecution, then they may be contrasted and compared to the cited patents which are separately linked at 2324.

If the patent or other IP type's prosecution history is substantial, then tools 2326 and 2328 can be helpful. In particular, tool 2326 can be used to organize the cited references in a tree structure—which is organized by the claims. Thus, if there are two independent claims and ten dependent claims under analysis—there are two trees, with cited references at their base, and each branch (first dependant claims) include the dependent claim references, for the claims that depend directly from the independent claims. Further branches are developed based on the dependencies.

A further optional feature is a citation analyzer based on user-defined criteria 2328. The analyzer allows users to define criteria for the reference, such as a pertinent feature or a relevant claim element.

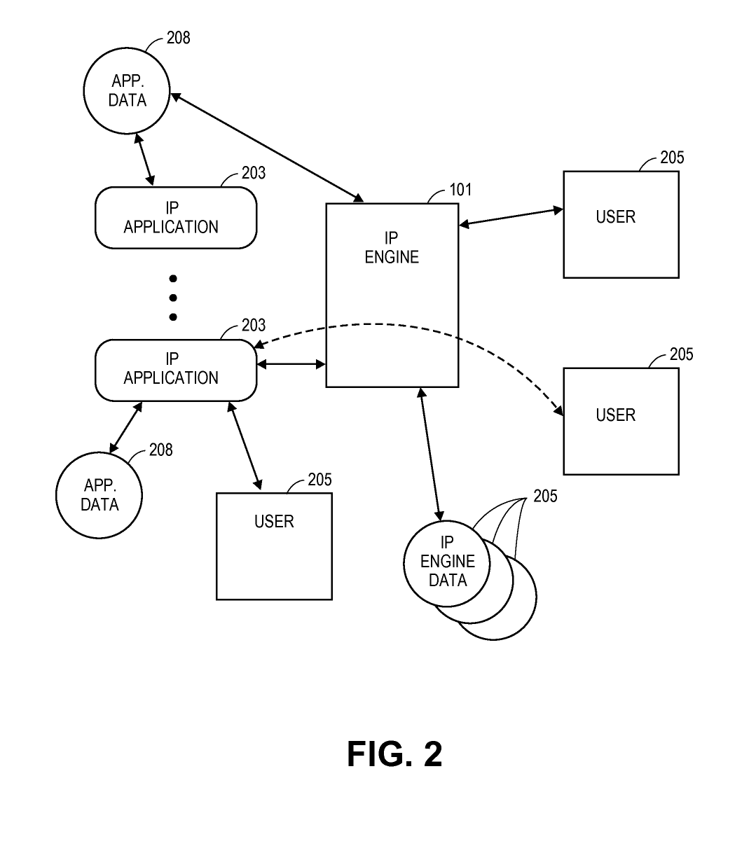

Reference is now made to FIG. 2, illustrating one potential data flow for the IP engine shown in FIG. 1. The IP engine 101 includes various ways to connect the user 205 to the IP application database, app. data 208 used by the various IP applications 203. According to at least one embodiment, the user 205 interacts directly with the IP engine 101; the IP engine translates the user's requests to the various IP applications, and enters commands to the IP application. According to one alternative, the IP engine 101 bypasses the IP application, and obtains the desired information directly from the IP application database, app. data 208. According to another embodiment, the user 205 interacts with the IP application in the usual manner, and interacts transparently with the IP engine 101. According to yet another embodiment, the user 205 interacts directly with the IP application 203 exclusive of the IP engine; such user may be provided with the IP engine's functionality by a direct interaction between the IP application and the IP engine. Hence, various embodiments provide user interaction with the IP engine directly, transparently, and/or via one or more IP applications.

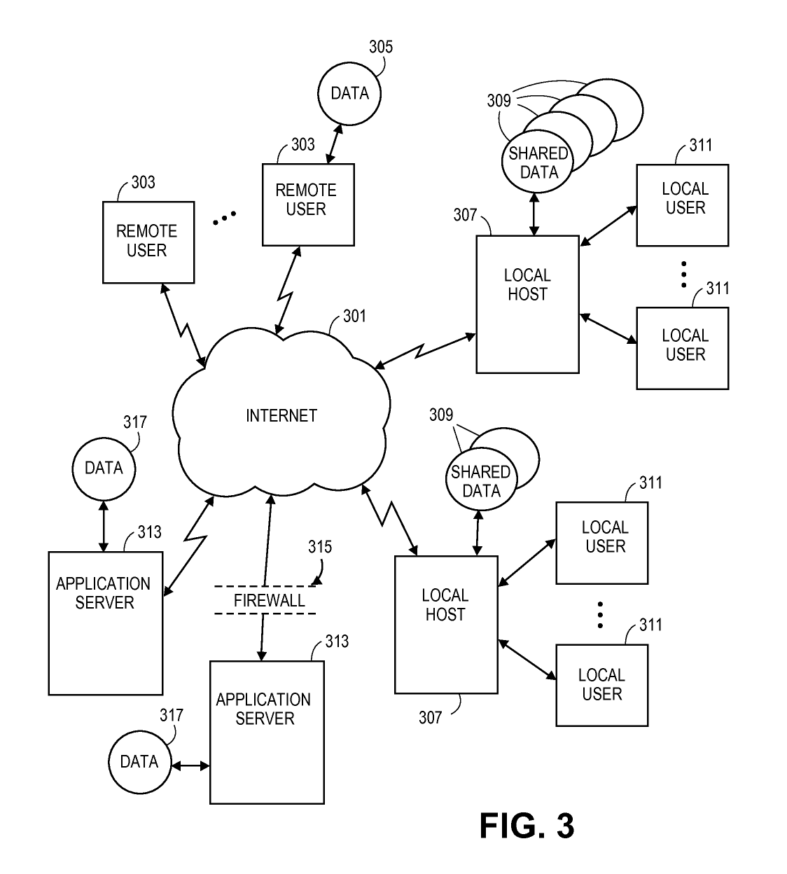

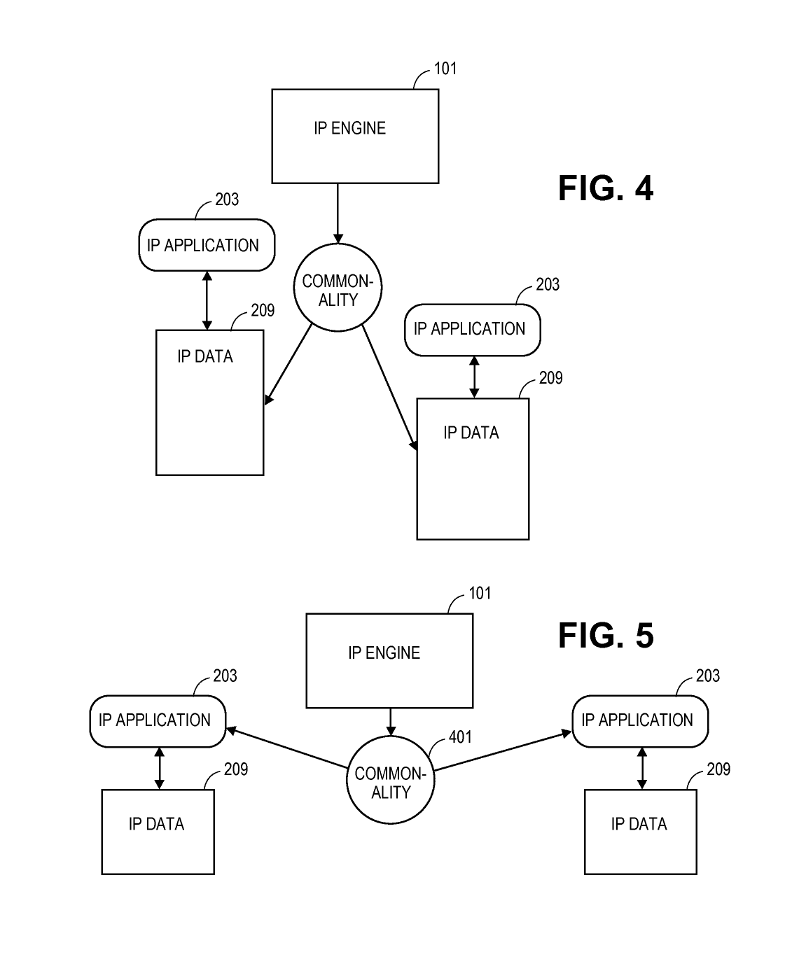

FIG. 3 provides an overview of an example network, encompassing IP information, in connection with which the present invention may be used. Although a number of elements are depicted in connection with the network, not all of the elements are required in order to operate the invention. As illustrated in FIG. 4, such a system may include an application server 313, data storage 317 connected thereto, and optionally, a firewall 315. The IP engine may execute on, e.g., the application server 313. The IP engine on the application server 313 stores and retrieves data (such as commonalities if stored separately) into the data storage 317, and transfers information in at least some embodiments through the firewall 315. IP application(s) could be executed on one or more of the application servers 313; such IP applications could store data in the data storage 317. Such a network also includes means for communicating over a network, such as an FTP server and/or web server on the application server 313, communicating with the Internet 301 or other communications network. A remote user 303 may utilize a browser or other user interface connected to the Internet 301, or other appropriate communications medium, for communication of user queries and responses to and from the IP engine 401. Optionally, the IP system may utilize any conventional communication system.

The IP engine on its server 313 may receive IP information from other servers 313 and/or local hosts 307. The local hosts 307, optionally communicating with local users 311, receive information representative of intellectual property information from, e.g., governmental entities (e.g., the USPTO) databases 309. The remote users 303 and/or local users use the communication lines to send commands, transmit requests and receive information to/from IP applications and/or the IP engine. The system may optionally receive IP information through other standard processes and/or systems.

There are also a number of ways in which information concerning IP may be retrieved, either directly or indirectly, from various sources. According to at least some embodiments, the IP information may be acquired by periodic polling, acquired on-demand, collected from public IP databases, and/or from some system that proffers IP information.

It may be desirable to have in place a device for remotely extracting IP information from, e.g., customers, and storing IP information in a central location. Such a device could be, for example, a modem dial-up system and standard POTS lines. Other remote communication devices and methods are possible, as well.

The IP engine and data storage may reside on the same server or computer 313, 307, 303, 311, or may be distributed and run on one or more separate servers and/or other computers. The functions of the IP engine may optionally be distributed among separate servers, programmed devices and/or computer systems.

Some users might prefer to utilize FTP for communication of data. Alternatively, the data representing the IP information may be transferred using any appropriate communication protocol. As another alternative, the remote user 303 stores the IP information in a remote database such as on a hard drive of a personal computer (PC) a mainframe, or other standard database, to be retrieved by the IP engine. Ultimately, the IP information that is received or retrieved is utilized by the IP engine.

FIGS. 4 and 5 illustrate two example uses by the IP engine 101 of a commonality 401 to bridge between various IP applications 203 and/or IP application data 209. In FIG. 4, the IP engine 101 accesses the commonality 401. Via the commonality 401, the IP engine 101 may directly access the IP data. This can be accomplished, for example by having the commonality index into the IP data. In contrast, in FIG. 5, the IP engine 101 accesses the IP data 209 indirectly by communicating vie the commonality 401 to the IP application 203 itself. Other ways may be used to use the commonality to bridge between the IP engine and/or the various IP applications.

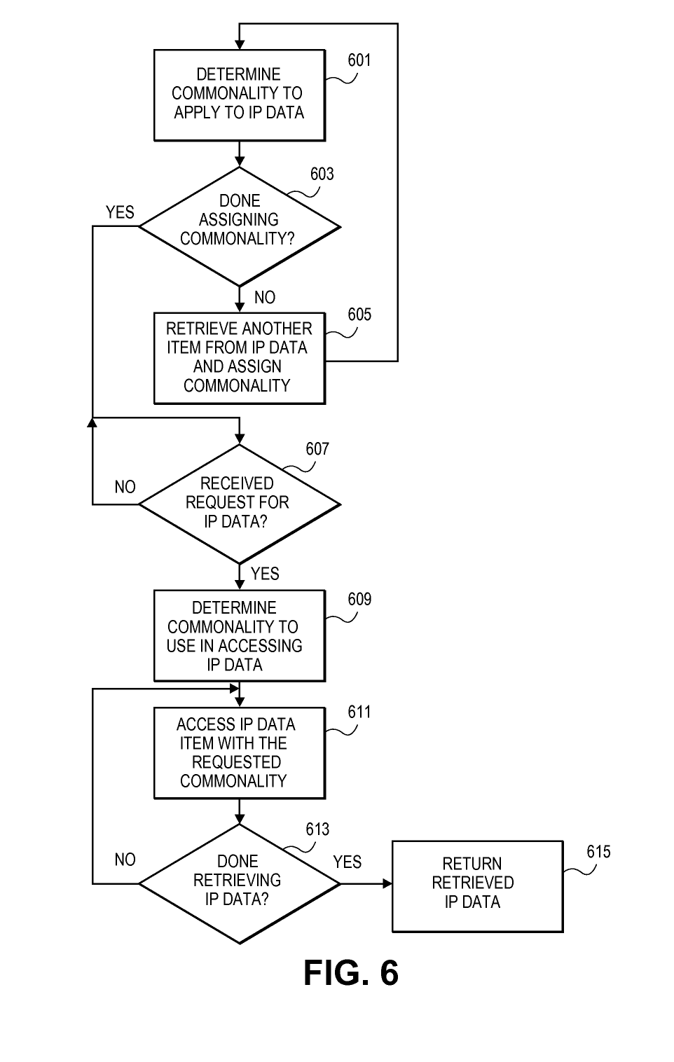

FIG. 6 is a flow chart illustrating one example flow of the IP engine. At block 601, the IP engine determines one (or more) commonality to apply to the current item of IP data. At block 603, the IP engine checks whether it is done assigning commonalities. (Commonalities could be assigned one item at a time, or the IP engine could be performing an ingestion of multiple items of IP data.) If not done, then at block 605, the IP engine retrieves another item from the IP data and assigns a commonality to it, and returns to block 601, to handle another data item. If done assigning commonalities, the IP engine at block 607 performs a wait loop for a request for IP data. Once a request for IP data has been received, the IP engine determines the commonality to use in accessing the requested IP data, at block 609. Then, at block 611, the IP engine accesses the IP data item with the requested commonality. At block 613, the IP engine checks whether it is done retrieving the IP data. If not, it proceeds back to block 611 and accesses further IP data items. On the other hand, if the IP engine is done retrieving IP data, then at block 615 the IP engine returns the retrieved IP data item.

According to alternative embodiments, the functions (concerning the assignment of commonality to items of IP data) in blocks 601-605 could be performed quite separately from the functions in blocks 607-615 (concerning the accessing of items of IP data via a commonality).

FIG. 7 is an illustration of a computer 58 used for implementing the computer processing in accordance with a computer-implemented embodiment of the present invention. The procedures described above may be presented in terms of program procedures executed on, for example, a computer or network of computers.

Viewed externally in FIG. 7, computer 48 has a central processing unit (CPU) 68 having disk drives 69, 70. Disk drives 69, 70 are merely symbolic of a number of disk drives that might be accommodated by computer 58. Typically, these might be one or more of the following: a floppy disk drive 69, a hard disk drive (not shown), and a CD ROM or digital video disk, as indicated by the slot at 70. The number and type of drives varies, typically with different computer configurations. Disk drives 69, 70 are, in fact, options, and for space considerations, may be omitted from the computer system used in conjunction with the processes described herein.

Computer 58 also has a display 71 upon which information may be displayed. The display is optional for the computer used in conjunction with the system described herein. A keyboard 72 and/or a pointing device 73, such as a mouse 73, may be provided as input devices to interface with central processing unit 68. To increase input efficiency, keyboard 72 may be supplemented or replaced with a scanner, card reader, or other data input device. The pointing device 73 may be a mouse, touch pad control device, track ball device, or any other type of pointing device.

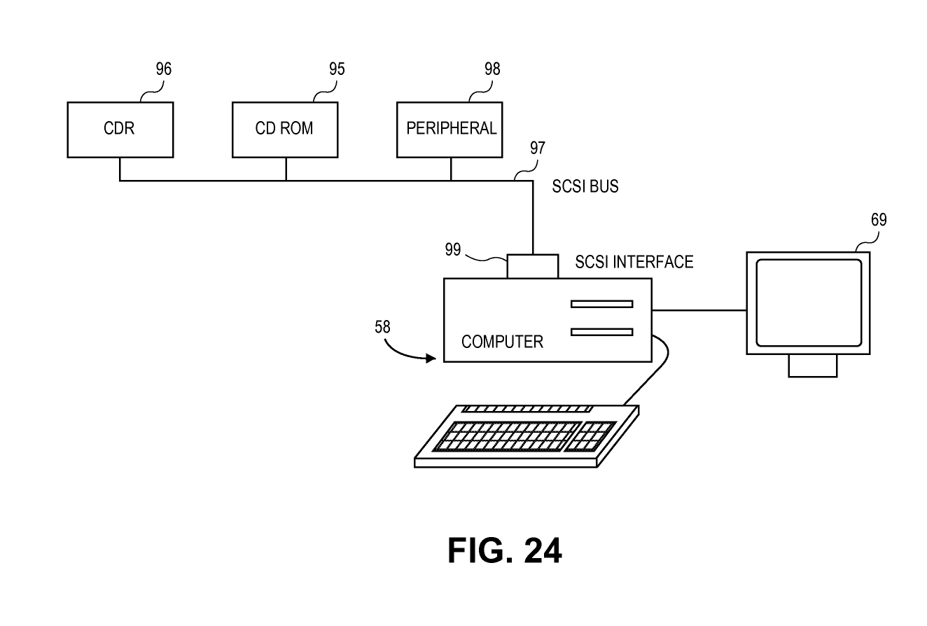

Alternatively, referring to FIG. 24, computer 58 may also include a CD ROM reader 95 and CD recorder 96, which are interconnected by a bus 97 along with other peripheral devices 98 supported by the bus structure and protocol. Bus 97 serves as the main information highway interconnecting other components of the computer. It is connected via an interface 99 to the computer 58.

FIG. 8 illustrates a block diagram of the internal hardware of the computer of FIG. 7. CPU 75 is the central processing unit of the system, performing calculations and logic operations required to execute a program. Read only memory (ROM) 76 and random access memory (RAM) 77 constitute the main memory of the computer.

Disk controller 78 interfaces one or more disk drives to the system bus 74. These disk drives may be floppy disk drives such as 79, or CD ROM or DVD (digital video/versatile disk) drives, as at 80, or internal or external hard drives 81. As previously indicated these various disk drives and disk controllers are optional devices.

A display interface 82 permits information from bus 74 to be displayed on the display 83. Again, as indicated, the display 83 is an optional accessory for a central or remote computer in the communication network, as are infrared receiver 88 and transmitter 89. Communication with external devices occurs using communications port 84.

In addition to the standard components of the computer, the computer may also include an interface 85, which allows for data input through the keyboard 86 or pointing device, such as a mouse 87.

Conventional processing system architecture is more fully discussed in Computer Organization and Architecture, by William Stallings, MacMillan Publishing Co. (3d ed. 1993). Conventional processing system network design is more fully discussed in Data Network Design, by Darren L. Spohn, McGraw-Hill, Inc. (1993). Conventional data communications is more fully discussed in Data Communications Principles, by R. D. Gitlin, J. F. Hayes, and S. B. Weinstain, Plenum Press (1992), and in The Irwin Handbook of Telecommunications, by James Harry Green, Irwin Professional Publishing (2d ed. 1992). Each of the foregoing publications is incorporated herein by reference.

The foregoing detailed description includes many specific details. The inclusion of such detail is for the purpose of illustration only and should not be understood to limit the invention. In addition, features in one embodiment may be combined with features in other embodiments of the invention. Various changes may be made without departing from the scope of the invention as defined in the following claims.

As one example, the information system may include a general purpose computer, or a specially programmed special purpose computer. Likewise, the billing engine may be a general purpose computer or specially programmed dedicated computer. Either of these may be implemented as a distributed computer system rather than a single computer. Similarly, the communications network that is illustrated as the World Wide Web or a modem over a POTS line, may include any other method of communicating between computers and/or billing devices. Moreover, the processing could be controlled by a software program on one or more computer system or processors, or could even be partially or wholly implemented in hardware, or could be partly embedded within various devices used for billing.

This invention is not limited to particular types of intellectual property. It is intended for use with any type of intellectual property, e.g., patents, trademarks, trade secrets, designs, sui generis protection, copyrights, licenses, litigations, and/or other rights.

Further, the invention is not limited to particular protocols for communication. Any appropriate communication protocol may be used with the meter devices.

The user displays may be developed in connection with HTML display format. Although HTML is the preferred display format, it is possible to utilize alternative display formats for displaying reports and obtaining user instructions. The invention has been discussed in connection with particular examples. However, the principals apply equally to other industries. Naturally, the relevant data may differ, as appropriate.

Further, this invention has been discussed in certain examples as if it is made available by a provider to a single customer with a single site. The invention may be used by numerous customers, if preferred. Also, the invention may be utilized by customers with multiple sites and/or agents and/or licensee-type arrangements.

The IP system used in connection with the invention may rely on the integration of various components including, as appropriate and/or if desired, hardware and software servers, applications software, database engines, firewall and SSL security, production back-up systems, and/or applications interface software. The configuration may be, preferably, network-based and optionally utilizes the Internet as an exemplary primary interface with the customer for information delivery.

The IP system may store collected information in a database. An appropriate database may be on a standard server, for example, a small Sun Sparc or other remote location. The database is optionally an MSQL, MYSQL, mini sequel server MiniSQL, or Oracle. Information is stored in the database, and optionally stored and backed up by a back-up server, periodically or aperiodically, for example, every night along with all other data in the servers that are behind the corporate firewall into a back-up storage facility. Back-up storage facility comprises, for example, one or more tape silos that are also used to back up the entire network every night. Data security and segregation of the various customers' data is advantageously maintained. The information, for example, will eventually get stored, for example, on a platform which may, for example be UNIX-based.

The various databases may be in, for example, a UNIX format, but other standard data formats may also be used. Windows NT, for example, is used, but other standard operating systems may also be used. Optionally, the various databases include a conversion system capable of receiving data in various standard formats.

From the user's perspective, according to some embodiments the user may access the public Internet or other suitable network and look at its specific information at any time from any location as long as it has Internet or other suitable access. For example, the user opens its standard web browser, goes to the address that is specified for its load data, and optionally fills out a user ID to log on, and a password to identify it as the specific user or the specific customer of that particular information.

Optionally, security of the networks is as tight as possible such that the data, not only customer data, but any information which is beyond the firewall is always protected against any kind of potential intrusion. The user, and, indeed, multiple users concurrently can look at the same information. Advantageously, having this system on the Internet enables users at various locations throughout the country or the world, to visit the same site at the same time and enter into a discussion or talk group as to what they are seeing, what it means, and maybe what they can do with that information.

Optionally, the IP system interfaces with an enterprise resource planning (“ERP”) system. ERP systems may be used to provide, for example, back office functions, front office functions, inventory, manufacturing, ordering, and/or accounting. One example of an ERP system is SAP™, available from SAP North America Inc. The IP system advantageously interfaces with the ERP by virtue of the commonality. If, for example, the commonality references products, and the ERP includes an inventory feature, it will be fairly straightforward for the IP engine to ascertain, e.g., for a trademark renewal, that the products are in use. The IP system may interface with other systems that can leverage off of one or more commonalities.

1-20. (canceled)

21. A computer system for electronic licensing, comprising:
a searchable database storing electronic copies of license agreements; and
a processor cooperatively operable with the searchable database, and configured to facilitate:
storing, in the searchable database, license agreements, the license agreements being segmented into separate legally analyzable sections; and
storing, in the searchable database separate from the license agreements, annotations of license agreements, the annotations being searchable and indexing into the legally analyzable sections.

22. The computer system of claim 21, wherein the processor is further configured to facilitate
receiving a search criteria for searching license agreements;
searching for the annotations which correspond to the search criteria; and
returning, as the search results, the license agreements indexed by the annotations which correspond to the search criteria.

23. The computer system of claim 22, wherein the searching for the search criteria further comprises referring to a cross-reference for alternative terminology for the search criteria.

24. The computer system of claim 22, wherein the searching for the search criteria further comprises referring to a thesaurus for alternative terminology for the search criteria.

25. The computer system of claim 22, wherein
the search criteria which is input is an identification of an intellectual property,
one of the annotations includes at least one identification of the intellectual property that indexes into at least one of the legally analyzable sections of the license agreement,
the intellectual property is a patent or a patent application.

26. The computer system of claim 21, wherein the processor is further configured to facilitate
receiving a search criteria for searching license agreements;
searching for the annotations which correspond to the search criteria; and
returning, as the search results, the legally analyzable sections of the license agreements indexed by the annotations which correspond to the search criteria.

27. The computer system of claim 21, wherein the processor is further configured to facilitate
storing, as an annotation, an indication that a legally analyzable section of the license agreement corresponds to a particular standard clause;
receiving a license clause, as a search criteria for searching license agreements;
searching for the annotations with the particular standard clause that corresponds to the search criteria; and
returning, as the search results, information regarding the license agreements indexed by the annotations which correspond to the search criteria, as license agreements which use a same standard license clause.

28. The computer system of claim 21, wherein the processor is further configured to facilitate storing real-time annotations of license agreements, video/audio recordings of negotiations, photographs embedded into license agreements, digitized images of license agreements, correspondence affiliated with license agreements, and exhibits from license agreements.

29. The computer system of claim 21, wherein the processor is further configured to facilitate
grouping a plurality of the license agreements from the searchable database into a licensing package; and
linking, in a traversable link, the licensing package to intellectual property assets which are licensed by the license agreements.

30. The computer system of claim 29, wherein the intellectual property assets that are linked to the license package are at least one of patents, trademarks, and copyrights.

31. The computer system of claim 21, wherein the processor is further configured to facilitate storing, in annotations of at least one license agreement, parties to an on-going negotiation of the at least one license agreement.

32. A computer-implemented method for electronic licensing, comprising:
providing a searchable database storing electronic copies of license agreements; and
storing, by a computer in the searchable database, license agreements, the license agreements being segmented into separate legally analyzable sections; and
storing, by the computer in the searchable database separate from the license agreements, annotations of license agreements, the annotations being searchable and indexing into the legally analyzable sections.

33. The method of claim 32, further comprising
receiving, in the computer, a search criteria for searching license agreements;
searching, in the computer, for the annotations which correspond to the search criteria; and
returning, in the computer as the search results, the license agreements indexed by the annotations which correspond to the search criteria.

34. The method of claim 33, wherein the searching for the search criteria further comprises referring to a cross-reference for alternative terminology for the search criteria.

35. The method of claim 33, wherein the searching for the search criteria further comprises referring to a thesaurus for alternative terminology for the search criteria.

36. The method of claim 33, wherein
the search criteria which is input is an identification of an intellectual property,
one of the annotations includes at least one identification of the intellectual property that indexes into at least one of the legally analyzable sections of the license agreement,
the intellectual property is a patent or a patent application.

37. The method of claim 32, further comprising
receiving, in the computer, a search criteria for searching license agreements;
searching, in the computer, for the annotations which correspond to the search criteria; and
returning, in the computer as the search results, the legally analyzable sections of the license agreements indexed by the annotations which correspond to the search criteria.

38. The method of claim 32, further comprising
storing, by the computer as an annotation, an indication that a legally analyzable section of the license agreement corresponds to a particular standard clause;
receiving, in the computer, a license clause, as a search criteria for searching license agreements;
searching, in the computer, for the annotations with the particular standard clause that corresponds to the search criteria; and
returning, by the computer as the search results, information regarding the license agreements indexed by the annotations which correspond to the search criteria, as license agreements which use a same standard license clause.

39. The method of claim 32, further comprising storing, in the computer, real-time annotations of license agreements, video/audio recordings of negotiations, photographs embedded into license agreements, digitized images of license agreements, correspondence affiliated with license agreements, and exhibits from license agreements.

40. The method of claim 32, further comprising
grouping, in the computer, a plurality of the license agreements from the searchable database into a licensing package; and
linking, in the computer, in a traversable link, the licensing package to intellectual property assets which are licensed by the license agreements.

41. The method of claim 40, wherein the intellectual property assets that are linked to the license package are at least one of patents, trademarks, and copyrights.

42. The method of claim 32, further comprising storing, by the computer, in annotations of at least one license agreement, parties to an on-going negotiation of the at least one license agreement.

43. A computer program stored on a non-transitory computer-readable storage medium, the computer program comprising instructions for execution by a computer, the instructions including a computer-implemented method for electronic licensing, the instructions for implementing:
providing a searchable database storing electronic copies of license agreements; and
storing, in the searchable database, license agreements, the license agreements being segmented into separate legally analyzable sections; and
storing, in the searchable database separate from the license agreements, annotations of license agreements, the annotations being searchable and indexing into the legally analyzable sections.

44. The computer program of claim 43, further comprising
receiving a search criteria for searching license agreements;
searching for the annotations which correspond to the search criteria; and
returning, as the search results, the license agreements indexed by the annotations which correspond to the search criteria.

45. The computer program of claim 44, wherein the searching for the search criteria further comprises referring to a cross-reference for alternative terminology for the search criteria.

46. The computer program of claim 44, wherein the searching for the search criteria further comprises referring to a thesaurus for alternative terminology for the search criteria.

47. The computer program of claim 44, wherein
the search criteria which is input is an identification of an intellectual property,
one of the annotations includes at least one identification of the intellectual property that indexes into at least one of the legally analyzable sections of the license agreement,
the intellectual property is a patent or a patent application.

48. The computer program of claim 43, further comprising
receiving a search criteria for searching license agreements;
searching for the annotations which correspond to the search criteria; and
returning, as the search results, the legally analyzable sections of the license agreements indexed by the annotations which correspond to the search criteria.

49. The computer program of claim 43, further comprising
storing, as an annotation, an indication that a legally analyzable section of the license agreement corresponds to a particular standard clause;
receiving a license clause, as a search criteria for searching license agreements;
searching for the annotations with the particular standard clause that corresponds to the search criteria; and
returning, as the search results, information regarding the license agreements indexed by the annotations which correspond to the search criteria, as license agreements which use a same standard license clause.

50. The computer program of claim 43, further comprising storing, in the computer, real-time annotations of license agreements, video/audio recordings of negotiations, photographs embedded into license agreements, digitized images of license agreements, correspondence affiliated with license agreements, and exhibits from license agreements.

51. The computer program of claim 43, further comprising
grouping a plurality of the license agreements from the searchable database into a licensing package; and
linking, in a traversable link, the licensing package to intellectual property assets which are licensed by the license agreements.

52. The computer program of claim 49, wherein the intellectual property assets that are linked to the license package are at least one of patents, trademarks, and copyrights.

53. The computer program of claim 43, further comprising storing, in annotations of at least one license agreement, parties to an on-going negotiation of the at least one license agreement.
